(19) United States
(12) Patent Application Publication
(10) Pub. No.: US 2026/0129398 A1
(43) Pub. Date: May 7, 2026

(54) METHOD AND DEVICE FOR TRANSFERRING SPEECH THROUGH VIRTUAL SPACE

(71) Applicant: Samsung Electronics Co., Ltd., Suwon-si (KR)

(72) Inventors: Myoungwoo NAM, Suwon-si (KR); Hyunsoo KIM, Suwon-si (KR); Nagyeom YOO, Suwon-si (KR); Jeaguk SHIM, Suwon-si (KR); Yoonho LEE, Suwon-si (KR); Sunghoon YIM, Suwon-si (KR)

(21) Appl. No.: 19/439,006

(22) Filed: Jan. 2, 2026

Related U.S. Application Data
(63) Continuation of application No. PCT/KR2024/007052, filed on May 24, 2024.

(30) Foreign Application Priority Data
Jul. 20, 2023 (KR) 10-2023-0094758
Sep. 22, 2023 (KR) 10-2023-0127047

(51) Int. Cl. H04S 7/00; G06F 3/16

(52) U.S. Cl. CPC H04S 7/303; G06F 3/165

(57) ABSTRACT

An electronic device is provided. The electronic device includes a processor, memory storing instructions, a display, and a speaker, wherein the instructions, when executed by the processor, cause the electronic device to receive, from other electronic device connected via communication, first acoustic data comprising voice data, obtain second acoustic data by reducing or eliminating, from the first acoustic data, an acoustic characteristic according to a physical space around the other electronic device, display a virtual object corresponding to the other electronic device through the display, identify a position and a heading direction of the other electronic device, obtain a voice output by adjusting the second acoustic data based on the identified position and the identified heading direction of the other electronic device, and reproduce the obtained speech output through the speaker.

### CROSS-REFERENCE TO RELATED APPLICATION(S)

This application is a continuation application, claiming priority under 35 U.S.C. § 365(c), of an International application No. PCT/KR2024/007052, filed on May 24, 2024, which is based on and claims the benefit of a Korean patent application number 10-2023-0094758, filed on Jul. 20, 2023, in the Korean Intellectual Property Office, and of a Korean patent application number 10-2023-0127047, filed on Sep. 22, 2023, in the Korean Intellectual Property Office, the disclosure of each of which is incorporated by reference herein in its entirety.

### BACKGROUND

### 1. Field

The disclosure relates to a technology for transferring speech through a virtual space.

### 2. Description of Related Art

Recently, virtual reality (VR), augmented reality (AR), and mixed reality (MR) technologies utilizing computer graphics technology have been developed. Here, the virtual-reality technology refers to technology of establishing a virtual space which does not exist in the real world by using a computer and making the virtual space feel real, and augmented-reality or mixed-reality technology refers to technology of adding information generated by a computer to the real world, that is, technology of combining a virtual world with the real world and enabling a real-time interaction with a user.

Among these technologies, AR and MR technologies are utilized in conjunction with technologies in various fields (e.g., broadcast technology, medical technology, game technology, etc.). Representative examples of integrating the augmented-reality technology and using the augmented-reality technology in the broadcast technology field are a smoothly changing weather map in front of a weather caster who delivers a weather forecast on television (TV) or an advertisement image, which does not exist in a stadium, inserted into a screen in a sports broadcast and broadcasted as if the advertisement image is real.

A representative service for providing a user with AR or MR is the “metaverse.” The metaverse is a compound word of ‘meta’ meaning virtual or abstract and ‘universe’ meaning a world, which refers to three-dimensional virtual reality. The metaverse is a more advanced concept than a typical virtual reality environment and provides an augmented-reality environment which absorbs virtual reality, such as a web and the Internet, in the real world.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for transferring speech through a virtual space.

Additional aspects will be set forth in part in the description which follows and, in part, will be apparent from the description, or may be learned by practice of the presented embodiments.

In accordance with an aspect of the disclosure, an electronic device is provided. The electronic device includes a processor, memory storing instructions, a display, and a speaker, wherein the instructions, when executed by the processor, cause the electronic device to receive, from other electronic device connected via communication, first acoustic data including voice data, obtain second acoustic data by reducing or eliminating, from the first acoustic data, an acoustic characteristic according to a physical space around the other electronic device, display a virtual object corresponding to the other electronic device through the display, identify a position and a heading direction of the other electronic device, obtain a voice output by adjusting the second acoustic data based on the identified position and the identified heading direction of the other electronic device, and reproduce the obtained voice output through the speaker.

In accordance with another aspect of the disclosure, a method performed by an electronic device is provided. The method includes receiving, from other electronic device connected via communication, first acoustic data including voice data, obtaining second acoustic data by reducing or eliminating, from the first acoustic data, an acoustic characteristic according to a physical space around the other electronic device, displaying a virtual object corresponding to the other electronic device through a display, identifying a position and a heading direction of the other electronic device, obtaining a voice output by adjusting the second acoustic data based on the identified position and the identified heading direction of the other electronic device, and reproducing the obtained voice output through a speaker.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from other electronic device connected via communication, first acoustic data comprising voice data, obtaining second acoustic data by reducing or eliminating, from the first acoustic data, an acoustic characteristic according to a physical space around the other electronic device, displaying a virtual object corresponding to the other electronic device through a display, identifying a position and a heading direction of the other electronic device, obtaining a voice output by adjusting the second acoustic data based on the identified position and the identified heading direction of the other electronic device, and reproducing the obtained voice output through a speaker.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic device, according to an embodiment of the disclosure;

FIG. 2 illustrates an optical see-through (OST) device according to an embodiment of the disclosure;

FIG. 3 illustrates an example of an optical system of an eye-tracking (ET) camera, a transparent member, and a display, according to an embodiment of the disclosure;

FIGS. 4A and 4B are diagrams illustrating examples of a front view and a rear view of an electronic device, according to various embodiments of the disclosure;

FIG. 5 illustrates an example of construction of a virtual space and an input from and an output to a user in the virtual space, according to an embodiment of the disclosure;

FIG. 6 is a diagram illustrating an example of transmitting voice data between a plurality of users in a virtual space, according to an embodiment of the disclosure;

FIG. 7 is a diagram illustrating an example of an electronic device, according to an embodiment of the disclosure;

FIG. 8 is a diagram illustrating an example of a method in which an electronic device reproduces a voice output generated from acoustic data of another electronic device, according to an embodiment of the disclosure;

FIGS. 9A, 9B, and 9C are diagrams illustrating examples of a speaking angle and a listening angle, according to various embodiments of the disclosure;

FIG. 10 is a diagram illustrating an example of an operation in which an electronic device attenuates a high-pitched component of acoustic data, according to an embodiment of the disclosure;

FIGS. 11A, 11B, and 11C are diagrams illustrating examples of an operation of determining a volume of a speaker, according to various embodiments of the disclosure; and

FIG. 12 illustrates an example of an interface of an electronic device, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

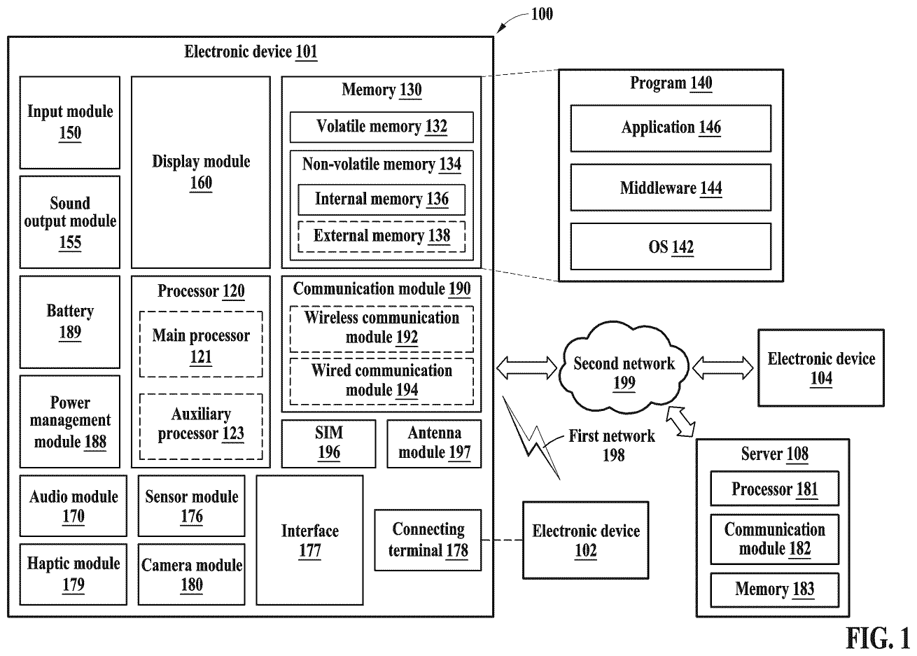

FIG. 1 is a block diagram illustrating a configuration of an electronic device, according to an embodiment of the disclosure.

FIG. 1 is a block diagram illustrating an electronic device in a network environment, according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., the electronic device 102) (e.g., a speaker or headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199.

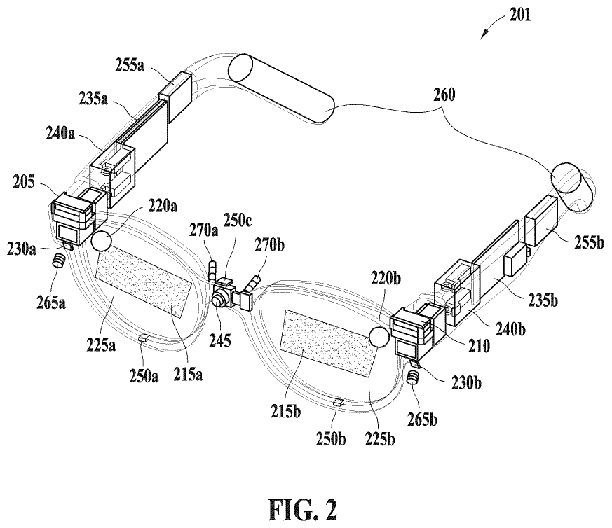

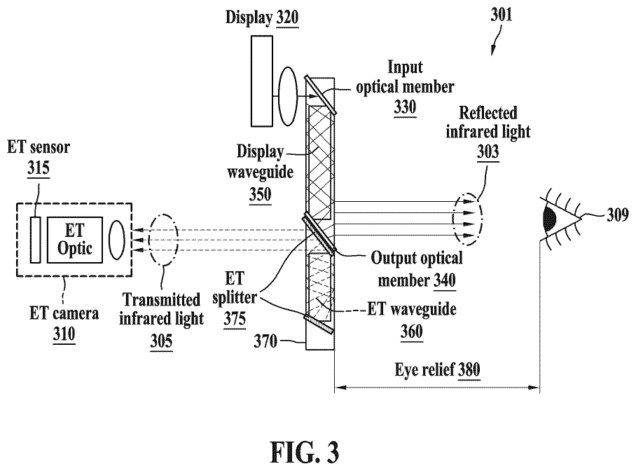

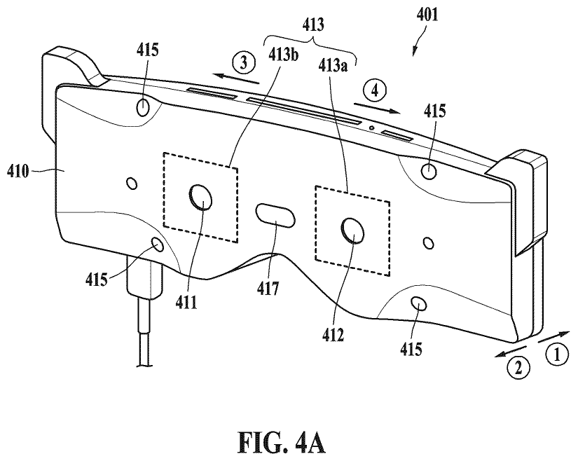

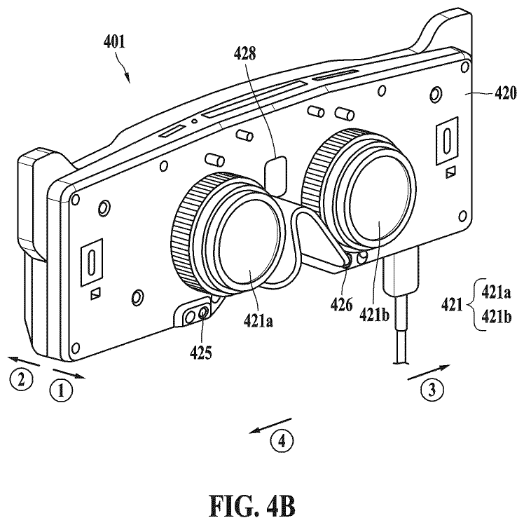

Each of the external electronic devices 102 and 104, and the server 108 may be a device of the same type as or a different type from the electronic device 101. According to an embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. In the disclosure, an example in which the electronic device 101 is an augmented reality (AR) device (e.g., an electronic device 201 of FIG. 2, an electronic device 301 of FIG. 3, or an electronic device 401 of FIGS. 4A and 4B), and the server 108 among the external electronic devices 102 and 104, and the server 108 transmits, to the electronic device 101, a result of executing a virtual space and an additional function or service associated with the virtual space will be mainly described.

The server 108 may include a processor 181, a communication module 182, and memory 183. The processor 181, the communication module 182, and the memory 183 may be similarly configured to the processor 120, the communication module 190, and the memory 130 of the electronic device 101. For example, the processor 181 may provide a virtual space and an interaction between users in the virtual space by executing instructions stored in the memory 183. The processor 181 may generate at least one of visual information, auditory information, or tactile information of the virtual space and objects in the virtual space. For example, as the visual information, the processor 181 may generate rendered data (e.g., visual rendered data) obtained by rendering an appearance (e.g., a shape, size, color, or texture) of the virtual space and an appearance (e.g., a shape, size, color, or texture) of an object positioned in the virtual space. Additionally, the processor 181 may generate rendered data obtained by rendering changes (e.g., a change in an appearance of an object, sound generation, or tactile sensation generation) based on at least one of an interaction between objects (e.g., a physical object, a virtual object, or an avatar object) in the virtual space, or a user input to an object (e.g., a physical object, virtual object, or avatar object). The communication module 182 may establish communication with a first electronic device (e.g., the electronic device 101) of a user and a second electronic device (e.g., the electronic device 102) of another user. The communication module 182 may transmit at least one of visual information, tactile information, or auditory information described above to the first electronic device and the second electronic device. For example, the communication module 182 may transmit rendered data.

For example, the server 108 may render content data executed in an application and transmit the rendered content data to the electronic device 101, and the electronic device 101 receiving the data may output the content data to the display module 160. When the electronic device 101 detects a movement of a user through an inertial measurement unit (IMU) sensor or the like, the processor 120 of the electronic device 101 may correct the rendered data received from the external electronic device 102 based on the movement information and output the corrected movement information to the display module 160. Alternatively, the processor 120 may transmit the movement information to the server 108 to request rendering such that screen data is updated accordingly. However, embodiments are not limited thereto, and the rendering may be performed by various types of external electronic devices (e.g., 102 and 104) such as a smartphone or a case device for storing and charging the electronic device 101. The rendered data corresponding to the virtual space generated by the external electronic devices 102 and 104 may be provided to the electronic device 101. In another example, the electronic device 101 may receive virtual spatial information (e.g., vertex coordinates, texture, and color defining a virtual space) and object information (e.g., vertex coordinates, texture, and color defining an appearance of an object) from the server 108 and perform rendering by itself based on the received data.

FIG. 2 illustrates an optical see-through (OST) device according to an embodiment of the disclosure.

An electronic device 201 may include at least one of a display (e.g., the display module 160 of FIG. 1), a vision sensor, light sources 230a and 230b, an optical element, or a substrate. The electronic device 201 including a transparent display and providing an image through the transparent display may be referred to as an OST device.

For example, the display may include a liquid crystal display (LCD), a digital mirror device (DMD), a liquid crystal on silicon (LCoS), an organic light-emitting diode (OLED), or a micro light-emitting diode (micro-LED).

In an embodiment, when the display is one of an LCD, a DMD, or an LCoS, the electronic device 201 may include the light sources 230a and 230b configured to emit light to a screen output area (e.g., screen display portions 215a and 215b) of the display. In another embodiment, when the display is capable of generating light by itself, for example, when the display is either the OLED or the micro-LED, the electronic device 201 may provide a virtual image with a relatively high quality to a user even though the separate light sources 230a and 230b are not included. In an embodiment, when the display is implemented as an OLED or a micro-LED, the light sources 230a and 230b may be unnecessary, which may lead to lightening of the electronic device 201.

Referring to FIG. 2, the electronic device 201 may include the display, a first transparent member 225a, and/or a second transparent member 225b, and the user may use the electronic device 201 while wearing the electronic device 201 on the face of the user. The first transparent member 225a and/or the second transparent member 225b may be formed of a glass plate, a plastic plate, or a polymer, and may be transparently or translucently formed. According to an embodiment, the first transparent member 225a may be disposed to face the right eye of the user, and the second transparent member 225b may be disposed to face the left eye of the user. The display may include a first display 205 configured to output a first image (e.g., a right image) corresponding to the first transparent member 225a and a second display 210 configured to output a second image (e.g., a left image) corresponding to the second transparent member 225b. According to an embodiment, when each display is transparent, the displays and the transparent members may be disposed to face the eyes of the user to configure the screen display portions 215a and 215b.

In an embodiment, a light path of light emitted from the displays 205 and 210 may be guided by a waveguide through input optical members 220a and 220b. Light moving into the waveguide may be guided toward the eyes of a user through an output optical member (e.g., an output optical member 340 of FIG. 3). The screen display portions 215a and 215b may be determined based on light emitted toward the eyes of the user.

For example, the light emitted from the displays 205 and 210 may be reflected from a grating region of the waveguide formed in the input optical members 220a and 220b and the screen display portions 215a and 215b, and may be transmitted to the eyes of the user.

The optical element may include at least one of a lens or an optical waveguide.

The lens may adjust a focus such that a screen output to the display may be visible to the eyes of the user. The lens may include, for example, at least one of a Fresnel lens, a pancake lens, or a multichannel lens.

The optical waveguide may transmit an image ray generated by the display to the eyes of the user. For example, the image rays may represent rays of light emitted by the light sources 230a and 230b, that pass through the screen output area of the display. The optical waveguide may be formed of glass, plastic, or polymer. The optical waveguide may have a nanopattern formed on one inside surface or one outside surface, for example, a grating structure of a polygonal or curved shape. A structure of the optical waveguide is described below with reference to FIG. 3.

The vision sensor may include at least one of a camera sensor or a depth sensor.

First cameras 265a and 265b, which are recognition cameras, may be cameras used for 3 degrees of freedom (DoF) or 6 DoF head tracking, hand detection, hand tracking, and space recognition. The first cameras 265a and 265b may mainly include a global shutter (GS) camera. Since a stereo camera is required for head tracking and space recognition, the first cameras 265a and 265b may include two or more GS cameras. A GS camera may have a more excellent performance compared to a rolling shutter (RS) camera, in terms of detecting and tracking a fine movement, such as a quick movement of a hand or a finger. For example, the GS camera may have a low image blur. The first cameras 265a and 265b may capture image data used for a simultaneous localization and mapping (SLAM) function through depth capturing and space recognition for 6DoF. In addition, a user gesture recognition function may be performed based on image data captured by the first cameras 265a and 265b.

Second cameras 270a and 270b, which are eye-tracking (ET) cameras, may be used to capture image data for detecting and tracking the pupils of the user. The second cameras 270a and 270b are described with reference to FIG. 3 below.

A third camera 245 may be a camera for image capturing. The third camera 245 may include a high-resolution (HR) camera to capture an HR image or a photo video (PV) image. The third camera 245 may include a color camera having functions for obtaining a high-quality image, such as, an automatic focus (AF) function and an optical image stabilizer (OIS). The third camera 245 may be a GS camera or an RS camera.

A fourth camera (e.g., face recognition cameras 425 and 426 of FIGS. 4A and 4B below) is a face recognition camera, and a face-tracking (FT) camera may be used to detect and track facial expressions of the user.

A depth sensor (not shown) may be a sensor configured to sense information for determining a distance to an object such as time of flight (TOF). The TOF is technology for measuring a distance to an object using a signal (e.g., a near infrared ray, ultrasound, laser, etc.). A TOF-based depth sensor may transmit a signal from a transmitter and measure the signal by a receiver, thereby measuring a TOF of the signal.

The light sources 230a and 230b (e.g., illumination modules) may include an element (e.g., an LED) configured to emit light of various wavelengths. The illumination module may be attached to various positions depending on the purpose of use. In an example of use, a first illumination module (e.g., an LED element), attached around a frame of an AR glasses device, may emit light for assisting gaze detection when tracking a movement of the eyes with an ET camera. The first illumination module may include, for example, an IR LED of an infrared wavelength. In another example of use, a second illumination module (e.g., an LED element) may be attached around hinges 240a and 240b connecting a frame and a temple or attached in proximity to a camera mounted around a bridge connecting the frame. The second illumination module may emit light for supplementing ambient brightness when the camera captures an image. When it is not easy to detect a subject in a dark environment, the second illumination module may emit light.

Substrates 235a and 235b (e.g., PCBs) may support the components described above.

The PCB may be disposed on temples of the glasses. A flexible PCB (FPCB) may transmit an electrical signal to each module (e.g., a camera, a display, an audio module, and a sensor module) and another PCB. According to an embodiment, at least one PCB may include a first substrate, a second substrate, and an interposer disposed between the first substrate and the second substrate. An electrical signal may be transmitted to each module and the other PCB.

The other components may include, for example, at least one of a plurality of microphones (e.g., a first microphone 250a, a second microphone 250b, and a third microphone 250c), a plurality of speakers (e.g., a first speaker 255a and a second speaker 255b), a battery 260, an antenna, or a sensor (e.g., an acceleration sensor, a gyro sensor, a touch sensor, etc.).

FIG. 3 illustrates an example of an optical system of an ET camera, a transparent member, and a display, according to an embodiment of the disclosure.

FIG. 3 is a diagram illustrating an operation of an ET camera included in an electronic device, according to an embodiment of the disclosure. FIG. 3 illustrates a process in which an ET camera 310 (e.g., a first ET camera 270a and a second ET camera 270b of FIG. 2) of an electronic device 301 according to an embodiment tracks an eye 309 of the user, that is, a gaze of the user, using light (e.g., infrared light) output from a display 320 (e.g., the first display 205 and the second display 210 of FIG. 2).

A second camera (e.g., the second cameras 270a and 270b of FIG. 2) may be the ET camera 310 that collects information for positioning the center of a virtual image projected onto the electronic device 301 according to a direction at which pupils of a wearer of the electronic device 301 gaze. The second camera may also include a GS camera to detect the pupils and track the rapid movement of the pupils. The ET cameras may be installed for the right eye and the left eye, and the ET cameras having the same camera performance and specifications may be used. The ET camera 310 may include an ET sensor 315. The ET sensor 315 may be included inside the ET camera 310. The infrared light output from the display 320 may be transmitted as reflected infrared light 303 to the eye 309 of the user by a half mirror. The ET sensor 315 may detect transmitted infrared light 305 that is generated when the reflected infrared light 303 is reflected from the eye 309 of the user. The ET camera 310 may track the eye 309 of the user, that is, the gaze of the user, based on the result of the detection by the ET sensor 315.

The display 320 may include a plurality of visible light pixels and a plurality of infrared pixels. The visible light pixels may include R, G, and B pixels. The visible light pixels may output visible light corresponding to a virtual object image. The infrared pixels may output infrared light. The display 320 may include, for example, micro LEDs or OLEDs.

A display waveguide 350 and an ET waveguide 360 may be included in a transparent member 370 (e.g., the first transparent member 225a and the second transparent member 225b of FIG. 2). The transparent member 370 may be formed as, for example, a glass plate, a plastic plate, or a polymer and may be transparently or translucently formed. The transparent member 370 may be disposed to face an eye of a user. In this case, a distance between the transparent member 370 and the eye 309 of the user may be referred to as an “eye relief” 380.

The transparent member 370 may include the display waveguide 350 and the ET waveguide 360. The transparent member 370 may include an input optical member 330 and an output optical member 340. In addition, the transparent member 370 may include an ET splitter 375 that splits input light into several waveguides.

According to an embodiment, light incident to one end of the display waveguide 350 may be propagated inside the display waveguide 350 by a nanopattern and may be provided to a user. In addition, the display waveguide 350 formed of a free-form prism may provide incident light as an image ray to the user through a reflection mirror. The display waveguide 350 may include at least one of a diffractive element (e.g., a diffractive optical element (DOE) or a holographic optical element (HOE)) or a reflective element (e.g., a reflection mirror). The display waveguide 350 may guide display light (e.g., an image ray) emitted from the light source to the eyes of the user, using at least one of the diffractive element or the reflective element included in the display waveguide 350. For reference, although FIG. 3 illustrates that the output optical member 340 is separate from the ET waveguide 360, the output optical member 340 may be included in the ET waveguide 360.

According to various embodiments, the diffractive element may include the input optical member 330 and the output optical member 340. For example, the input optical member 330 may refer, for example, to an “input grating region.” The output optical member 340 may refer, for example, to an “output grating region.” The input grating region may serve as an input end that diffracts (or reflects) light, that is output from a micro-LED, to transmit the light to a transparent member (e.g., a first transparent member and a second transparent member) of a screen display portion. The output grating region may serve as an exit that diffracts (or reflects), to the eyes of the user, the light transmitted to the transparent member (e.g., the first transparent member and the second transparent member) of a waveguide.

According to various embodiments, the reflective element may include a total internal reflection (TIR) waveguide or a TIR optical element for TIR. For example, TIR, which is one scheme for inducing light, may form an angle of incidence such that light (e.g., a virtual image) entering through the input grating region is completely reflected from one surface (e.g., a specific surface) of the waveguide, to completely transmit the light to the output grating region.

In an embodiment, a light path of the light emitted from the display 320 may be guided by the waveguide through the input optical member 330. The light moving into the waveguide may be guided toward the eyes of the user through the output optical member 340. The screen display portion may be determined based on the light emitted toward the eyes of the user.

FIGS. 4A and 4B are diagrams illustrating examples of a front view and a rear view of an electronic device, according to various embodiments of the disclosure.

FIG. 4A may be an appearance of an electronic device 401 viewed in a first direction \textcircled{1}, and FIG. 4B may be an appearance of the electronic device 401 viewed in a second direction \textcircled{2}. When a user wears the electronic device 401, the appearance viewed by the user's eyes may be illustrated in FIG. 4B.

Referring to FIG. 4A, according to various embodiments, the electronic device 401 (e.g., the electronic device 101 of FIG. 1, the electronic device 201 of FIG. 2, or the electronic device 301 of FIG. 3) may provide a service providing an extended reality (XR) experience to the user. For example, the XR or XR service may be defined as a service that collectively refers to virtual reality (VR), AR, and/or mixed reality (MR).

According to an embodiment, the electronic device 401 may refer to a head-mounted device or head-mounted display (HMD) worn on the head of the user but may be provided in the form of at least one of glasses, goggles, a helmet, or a hat. The electronic device 401 may include some types such as an OST type configured such that, when being worn, external light reaches the eyes of the user through glasses or a video see-through (VST) type configured such that, when being worn, light emitted from a display reaches the eyes of the user but external light is blocked not to reach the eyes of the user.

According to an embodiment, the electronic device 401 may be worn on the head of the user and provide images related to an XR service to the user. For example, the electronic device 401 may provide XR content (hereinafter, also referred to as an XR content image) output such that at least one virtual object is visible overlapping in a display area or an area determined to be a field of view (FOV) of the user. According to an embodiment, the XR content may refer to an image related to a real space obtained through a camera (e.g., an image-capturing camera) or an image or video in which at least one virtual object is added to a virtual space. According to an embodiment, the electronic device 401 may provide XR content based on a function being performed by the electronic device 401 and/or a function being performed by one or more external electronic devices of external electronic devices (e.g., the electronic devices 102 and 104 of FIG. 1 and the server 108 of FIG. 1).

According to an embodiment, the electronic device 401 may be at least partially controlled by an external electronic device (e.g., the electronic device 102 or 104 of FIG. 1), or may perform at least one function under the control of the external electronic device or perform at least one function independently.

Referring to FIG. 4A, a vision sensor may be disposed on a first surface of a housing of a main body 410 of the electronic device 401. The vision sensor may include cameras (e.g., second function cameras 411 and 412, and first function cameras 415) and/or a depth sensor 417 for obtaining information related to the surrounding environment of the electronic device 401.

In an embodiment, the second function cameras 411 and 412 may obtain images related to the surrounding environment of the electronic device 401. With a wearable electronic device worn by the user, the first function cameras 415 may obtain images. The first function cameras 415 may be used for hand detection and tracking, and recognition of gestures (e.g., hand gestures) of the user. The first function cameras 415 may be used for 3 DoF and 6 DoF head tracking, position (space, environment) recognition, and/or movement recognition. In an embodiment, the second function cameras 411 and 412 may also be used for hand detection and tracking, and the recognition of user gestures.

In an embodiment, the depth sensor 417 may be configured to transmit a signal and receive a signal reflected from an object and may be used to determine a distance to an object based on the TOF. Alternatively of or additionally, the cameras 411, 412, and 415 may determine the distance to the object in place of the depth sensor 417.

Referring to FIG. 4B, the face recognition cameras 425 and 426 and/or a display 421 (and/or a lens) may be disposed on a second surface 420 of the housing of the main body 410.

In an embodiment, the face recognition cameras 425 and 426 adjacent to a display may be used to recognize the face of the user or may recognize and/or track both eyes of the user.

In an embodiment, the display 421 (and/or a lens) may be disposed on the second surface 420 of the electronic device 401. In an embodiment, the electronic device 401 may not include some of the plurality of cameras 415. Although not shown in FIGS. 4A and 4B, the electronic device 401 may further include at least one of the components shown in FIG. 2.

According to an embodiment, the electronic device 401 may include the main body 410 on which at least some of the components of FIG. 1 are mounted, the display 421 (e.g., the display module 160 of FIG. 1) disposed in the first direction \textcircled{1} of the main body 410, the first function cameras 415 (e.g., recognition cameras) disposed in the second direction \textcircled{2} of the main body 410, the second function cameras 411 and 412 (e.g., image-capturing cameras) disposed in the second direction \textcircled{2}, a third function camera 428 (e.g., an ET camera) disposed in the first direction \textcircled{1}, fourth function cameras (e.g., the face recognition cameras 425 and 426) disposed in the first direction \textcircled{1}, the depth sensor 417 disposed in the second direction \textcircled{2}, and a touch sensor 413 disposed in the second direction \textcircled{2}. Although not shown in the drawings, the main body 410 may include memory (e.g., the memory 130 of FIG. 1) and a processor (e.g., the processor 120 of FIG. 1) therein and may further include other components shown in FIG. 1.

According to an embodiment, the display 421 may include an LCD, a DMD, an LCoS device, an OLED, or a micro-LED.

In an embodiment, when the display 421 is one of an LCD, a DMD, or an LCoS device, the electronic device 401 may include a light source that emits light to a screen output area of the display 421. In another embodiment, when the display 421 is capable of generating light by itself, for example, when the electronic device 401 is formed of one of an OLED or a micro-LED, the electronic device 401 may provide an XR content image with a relatively high quality to the user, even though a separate light source is not included. In an embodiment, when the display 421 is implemented as an OLED or a micro-LED, a light source may be unnecessary, which may lead to lightening of the electronic device 401.

According to an embodiment, the display 421 may include a first transparent member 421a and/or a second transparent member 421b. The user may use the electronic device 401 with the electronic device 401 worn on the face. The first transparent member 421a and/or the second transparent member 421b may be formed of a glass plate, a plastic plate, or a polymer and may be transparently or translucently formed. According to an embodiment, the first transparent member 421a may be disposed to face the left eye of the user in a fourth direction \textcircled{4}, and the second transparent member 421b may be disposed to face the right eye of the user in a third direction \textcircled{3}. According to various embodiments, when the display 421 is transparent, the display 421 may be disposed at a position facing the eyes of the user to form a display area.

According to an embodiment, the display 421 may include a lens including a transparent waveguide. The lens may serve to adjust the focus such that a screen (e.g., an XR content image) output to the display 421 is to be viewed by the eyes of the user. For example, light emitted from a display panel may pass through the lens and be transmitted to the user through the waveguide formed within the lens. The lens may include, for example, a Fresnel lens, a pancake lens, or a multichannel lens.

An optical waveguide (e.g., a waveguide) may serve to transmit a light source generated by the display 421 to the eyes of the user. The optical waveguide may be formed of glass, plastic, or a polymer and may have a nanopattern formed on a portion of an inner or outer surface, for example, a grating structure of a polygonal or curved shape. According to an embodiment, light incident to one end of the optical waveguide, that is, an output image of the display 421 may be propagated inside the optical waveguide to be provided to the user. In addition, the optical waveguide formed of a free-form prism may provide the incident light to the user through a reflection mirror. The optical waveguide may include at least one of diffractive elements (e.g., a DOE and an HOE) or at least one of reflective elements (e.g., a reflection mirror). The optical waveguide may guide an image output from the display 421 to the eyes of the user using the at least one diffractive element or reflective element included in the optical waveguide.

According to an embodiment, the diffractive element may include an input optical member/output optical member (not shown). For example, the input optical member may refer to an input grating region, and the output optical member (not shown) may refer to an output grating region. The input grating region may serve as an input end that diffracts (or reflects) light, output from a light source (e.g., a micro-LED), to transmit the light to a transparent member (e.g., the first transparent member 421a and the second transparent member 421b) of the display area. The output grating region may serve as an exit that diffracts (or reflects), to the eyes of the user, the light transmitted to the transparent member (e.g., the first transparent member and the second transparent member) of the optical waveguide.

According to various embodiments, the reflective element may include a TIR optical element or a TIR waveguide for TIR. For example, TIR, which is a scheme for guiding light, may generate an angle of incidence such that light (e.g., a virtual image) input through the input grating region is substantially completely reflected from one surface (e.g., a specific surface) of the optical waveguide, to completely transmit the light to the output grating region.

In an embodiment, a light path of light emitted from the display 421 may be guided by the waveguide through the input optical member. Light moving into the optical waveguide may be guided toward the eyes of the user through the output optical member. The display area may be determined based on the light emitted in the direction of the eyes.

According to an embodiment, the electronic device 401 may include a plurality of cameras. For example, the cameras may include the first function cameras 415 (e.g., recognition cameras) disposed in the second direction \textcircled{2} of the main body 410, the second function cameras 411 and 412 (e.g., image-capturing cameras) disposed in the second direction \textcircled{2}, the third function camera 428 (e.g., an ET camera) disposed in the first direction \textcircled{1}, and/or the fourth function cameras (e.g., the face recognition cameras 425 and 426) disposed in the first direction \textcircled{1}, and may further include other function cameras (not shown).

The first function cameras 415 (e.g., the recognition cameras) may be used for a function of detecting a movement of the user or recognizing a gesture of the user. The first function cameras 415 may support at least one of head tracking, hand detection and hand tracking, and space recognition. For example, the first function cameras 415 may mainly use a GS camera having excellent performance compared to an RS camera to detect and track fine gestures or movements of hands and fingers and may be configured as a stereo camera including two or more GS cameras for head tracking and space recognition. The first function cameras 415 may perform functions, such as, 6 DoF space recognition, and a SLAM function for recognizing information (e.g., a position and/or direction) associated with a surrounding space through depth imaging.

The second function cameras 411 and 412 (e.g., the image-capturing cameras) may be used to capture images of the outside, generate an image or video corresponding to the outside, and transmit the image or video to a processor (e.g., the processor 120 of FIG. 1). The processor may display the image provided from the second function cameras 411 and 412 on the display 421. The second function cameras 411 and 412 may also be referred to as HR or PV cameras and may include an HR camera. For example, the second function cameras 411 and 412 may include color cameras equipped with a function for obtaining high-quality images, such as an AF function and OIS, but are not limited thereto. The second function cameras 411 and 412 may also include a GS camera or an RS camera.

The third function camera 428 (e.g., the ET camera) may be disposed on the display 421 (or inside the main body) such that camera lenses face the eyes of the user when the user wears the electronic device 401. The third function camera 428 may be used for detecting and tracking the pupils (e.g., ET). The processor may verify a gaze direction by tracking movements of the left eye and the right eye of the user in an image received from the third function camera 428. By tracking the positions of the pupils in the image, the processor may be configured such that the center of an XR content image displayed on the display area is positioned according to a direction in which the pupils are gazing. For example, the third function camera 428 may use a GS camera to detect the pupils and track the movements of the pupils. The third function camera 428 may be installed for each of the left eye and the right eye and may have the same camera performance and specifications.

The fourth function cameras (e.g., the face recognition cameras 425 and 426) may be used to detect and track a facial expression of the user (e.g., FT) when the user wears the electronic device 401.

According to an embodiment, the electronic device 401 may include a lighting unit (e.g., LED) (not shown) as an auxiliary means for cameras. For example, the third function camera 428 may use a lighting unit included in a display as an auxiliary means for facilitating gaze detection when tracking eye movements, to direct emitted light (e.g., IR LED of an IR wavelength) toward both eyes of the user. In another example, the second function cameras 411 and 412 may further include a lighting unit (e.g., a flash) as an auxiliary means for supplementing surrounding brightness when capturing an image of the outside.

According to an embodiment, the depth sensor 417 (or a depth camera) may be used to verify a distance to an object (e.g., a target) through, for example, TOF. TOF, which is technology for measuring a distance to an object using a signal (e.g., near-infrared rays, ultrasound, or laser), may transmit a signal from a transmitter and then measure the signal by a receiver, and may measure a distance to an object based on the TOF of the signal.

According to an embodiment, the touch sensor 413 may be disposed in the second direction \textcircled{2} of the main body 410. For example, when the user wears the electronic device 401, the eyes of the user may view in the first direction \textcircled{1} of the main body. The touch sensor 413 may be implemented as a single type or a left/right separated type based on the shape of the main body 410 but is not limited thereto. For example, in a case in which the touch sensor 413 is implemented as the left/right separated type as shown in FIG. 4A, when the user wears the electronic device 401, a first touch sensor 413a may be disposed at a position corresponding to the left eye of the user in the fourth direction \textcircled{4}, and a second touch sensor 413b may be disposed at a position corresponding to the right eye of the user in the third direction \textcircled{3}.

The touch sensor 413 may recognize a touch input using at least one of, for example, capacitive, resistive, infrared, or ultrasonic method. For example, the touch sensor 413 using the capacitive method may recognize a physical touch (or contact) input or hovering (or proximity) input of an external object. According to some embodiments, the electronic device 401 may use a proximity sensor (not shown) to recognize the proximity to an external object.

According to an embodiment, the touch sensor 413 may have a two-dimensional (2D) surface and transmit, to a processor (e.g., the processor 120 of FIG. 1), touch data (e.g., touch coordinates) of an external object (e.g., a finger of the user) contacting the touch sensor 413. The touch sensor 413 may detect a hovering input of an external object (e.g., a finger of the user) approaching within a first distance away from the touch sensor 413 or detect a touch input contacting the touch sensor 413.

In an embodiment, the touch sensor 413 may provide 2D information about the contact point to the processor 120 as “touch data” when an external object touches the touch sensor 413. The touch data may be described as a “touch mode.” When the external object is positioned within the first distance from the touch sensor 413 (or hovers above a proximity or touch sensor), the touch sensor 413 may provide hovering data about a time point or position of the external object hovering around the touch sensor 413 to the processor 120. The hovering data may also be described as a “hovering mode/proximity mode.”

According to an embodiment, the electronic device 401 may obtain the hovering data using at least one of the touch sensor 413, a proximity sensor (not shown), and/or the depth sensor 417 to generate information about a distance between the touch sensor 413 and an external object, a position, or a time point.

According to an embodiment, the main body 410 may include a processor (e.g., the processor 120 of FIG. 1) and memory (e.g., the memory 130 of FIG. 1) therein.

The memory may store various instructions that may be executed by the processor. The instructions may include control instructions, such as arithmetic and logical operations, data movement, or input/output, which may be recognized by the processor. The memory may include a volatile memory (e.g., the volatile memory 132 of FIG. 1) and a non-volatile memory (e.g., the non-volatile memory 134 of FIG. 1) to store, temporarily or permanently, various pieces of data.

The processor may be operatively, functionally, and/or electrically connected to each of the components of the electronic device 401 to perform control and/or communication-related computation or data processing of each of the components. The operations performed by the processor may be stored in the memory and, when executed, may be executed by the instructions that cause the processor to operate.

Although there will be no limitation to the computation and data processing functions implemented by the processor on the electronic device 401, a series of operations related to an XR content service function will be described hereinafter. The operations of the processor to be described below may be performed by executing the instructions stored in the memory.

According to an embodiment, the processor may generate a virtual object based on virtual information based on image information. The processor may output a virtual object related to an XR service along with background spatial information through the display 421. For example, the processor may obtain image information by capturing an image related to a real space corresponding to an FOV of the user wearing the electronic device 401 through the second function cameras 411 and 412 or may generate a virtual space of a virtual environment. For example, the processor may perform control to display, on the display 421, XR content (hereinafter, referred to as an XR content screen) that outputs at least one virtual object such that the at least one virtual object is visible overlapping in an FOV area or an area determined to be the FOV of the user.

According to an embodiment, the electronic device 401 may have a form factor to be worn on the head of the user. The electronic device 401 may further include a strap and/or a wearing member to be fixed on the body part of the user. The electronic device 401 may provide a VR, AR, and/or MR-based user experience while being worn on the head of the user.

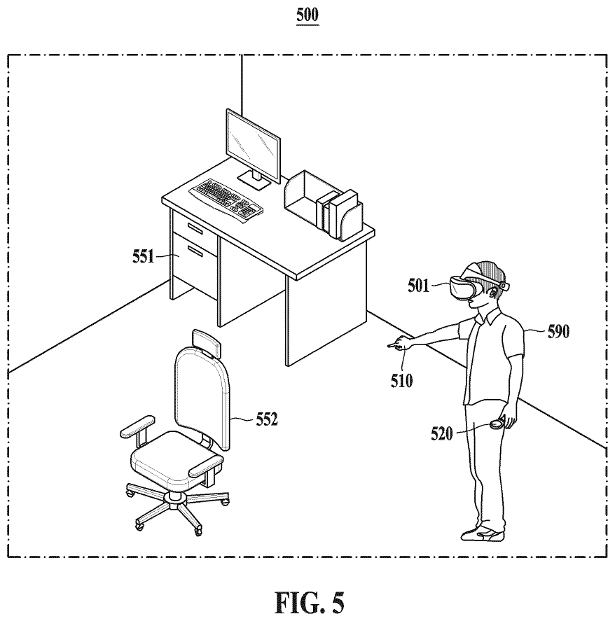

FIG. 5 illustrates an example of the construction of a virtual space and an input from and an output to a user in the virtual space, according to an embodiment of the disclosure.

Referring to FIG. 5, an electronic device (e.g., the electronic device 101 of FIG. 1, the electronic device 201 of FIG. 2, the electronic device 301 of FIG. 3, and the electronic device 401 of FIGS. 4A and 4B) may obtain spatial information about a physical space in which sensors are located using the sensors. The spatial information may include a geographic location of the physical space in which the sensors are located, a size of the space, an appearance of the space, a position of a physical object 551 disposed in the space, a size of the physical object 551, an appearance of the physical object 551, and illuminant information. The appearance of the space and the physical object 551 may include at least one of a shape, a texture, or a color of the space and the physical object 551. The illuminant information, which is information about a light source that emits light acting in the physical space, may include at least one of an intensity, a direction, or a color of illumination. The sensors described above may collect information for providing AR. For example, in an AR device shown in FIG. 2 3, 4A, and 4B, the sensors may include a camera and a depth sensor. However, the sensors are not limited thereto, and the sensors may further include at least one of an infrared sensor, a depth sensor (e.g., a light detection and ranging (LiDAR) sensor, a radio detection and ranging (radar) sensor, or a stereo camera), a gyro sensor, an acceleration sensor, or a geomagnetic sensor.

An electronic device 501 may collect the spatial information over a plurality of time frames. For example, in each time frame, the electronic device 501 may collect information about a space of a portion belonging to a scene within a sensing range (e.g., an FOV) of a sensor at a position of the electronic device 501 in the physical space. The electronic device 501 may analyze the spatial information of the time frames to track a change (e.g., a position movement or state change) of an object over time. The electronic device 501 may integrally analyze the spatial information collected through the plurality of sensors to obtain integrated spatial information (e.g., an image obtained by spatially stitching scenes around the electronic device 501 in the physical space) of an integrated sensing range of the plurality of sensors.

According to an embodiment, the electronic device 501 may analyze the physical space as three-dimensional (3D) information, using various input signals (e.g., sensing data of an RGB camera, an infrared sensor, a depth sensor, or a stereo camera) of the sensors. For example, the electronic device 501 may analyze at least one of the shape, the size, or the position of the physical space, and the shape, the size, or the position of the physical object 551.

For example, the electronic device 501 may detect an object captured in a scene corresponding to an FOV of a camera, using sensing data (e.g., a captured image) of the camera. The electronic device 501 may determine a label of the physical object 551 (e.g., as information indicating classification of an object, including values indicating a chair, a monitor, or a plant) from a 2D scene image of the camera and an area (e.g., a bounding box) occupied by the physical object 551 in the 2D scene. Accordingly, the electronic device 501 may obtain 2D scene information from a position at which a user 590 is viewing. In addition, the electronic device 501 may also calculate a position of the electronic device 501 in the physical space based on the sensing data of the camera.

The electronic device 501 may obtain position information of the user 590 and depth information of a real space in a viewing direction, using sensing data (e.g., depth data) of a depth sensor. The depth information, which is information indicating a distance from the depth sensor to each point, may be expressed in the form of a depth map. The electronic device 501 may analyze a distance in the unit of each pixel at a 3D position at which the user 590 is viewing.

The electronic device 501 may obtain information including a 3D point cloud and mesh using various pieces of sensing data. The electronic device 501 may obtain a plane, a mesh, or a 3D coordinate point cluster that configures the space by analyzing the physical space. The electronic device 501 may obtain a 3D point cloud representing physical objects based on the information obtained as described above.

The electronic device 501 may obtain information including at least one of 3D position coordinates, 3D shapes, or 3D sizes (e.g., 3D bounding boxes) of the physical objects arranged in the physical space by analyzing the physical space.

Accordingly, the electronic device 501 may obtain physical object information detected in the 3D space and semantic segmentation information about the 3D space. The physical object information may include at least one of a position, an appearance (e.g., a shape, texture, and color), or a size of the physical object 551 in the 3D space. The semantic segmentation information, which is information obtained by semantically segmenting the 3D space into subspaces, may include, for example, information indicating that the 3D space is segmented into an object and a background and information indicating that the background is segmented into a wall, a floor, and a ceiling. As described above, the electronic device 501 may obtain and store 3D information (e.g., spatial information) about the physical object 551 and the physical space. The electronic device 501 may store 3D position information of the user 590 in the space, along with the spatial information.

The electronic device 501 according to an embodiment may construct a virtual space 500 based on the physical positions of the electronic device 501 and/or the user 590. The electronic device 501 may generate the virtual space 500 by referring to the spatial information described above. The electronic device 501 may generate the virtual space 500 of the same scale as the physical space based on the spatial information and arrange objects in the generated virtual space 500. The electronic device 501 may provide a complete VR to the user 590 by outputting an image that substitutes the entire physical space. The electronic device 501 may provide MR or AR by outputting an image that substitutes a portion of the physical space. Although the construction of the virtual space 500 based on the spatial information obtained by the analysis of the physical space is described, the electronic device 501 may also construct the virtual space 500 irrespective of the physical position of the user 590. The virtual space 500 described herein may be a space corresponding to AR or VR and may also be referred to as a metaverse space.

For example, the electronic device 501 may provide a virtual graphic representation that substitutes at least a partial space of the physical space. The electronic device 501, which is an OST-based electronic device, may output the virtual graphic representation overlaid on a screen area corresponding to at least a partial space of a screen display portion. The electronic device 501, which is a VST-based electronic device, may output an image generated by substituting an image area corresponding to at least a partial space in a space image corresponding to a physical space rendered based on the spatial information with a virtual graphic representation. The electronic device 501 may substitute at least a portion of a background in the physical space with a virtual graphic representation, but embodiments are not limited thereto. The electronic device 501 may only additionally arrange a virtual object 552 in the virtual space 500 based on the spatial information, without changing the background.

The electronic device 501 may arrange and output the virtual object 552 in the virtual space 500. The electronic device 501 may set a manipulation area for the virtual object 552 in a space occupied by the virtual object 552 (e.g., a volume corresponding to an appearance of the virtual object 552). The manipulation area may be an area in which a manipulation of the virtual object 552 occurs. In addition, the electronic device 501 may substitute the physical object 551 with the virtual object 552 and output the virtual object 552. The virtual object 552 corresponding to the physical object 551 may have the same or similar shape as or to the corresponding physical object 551. However, embodiments are not limited thereto, and the electronic device 501 may set only the manipulation area in a space occupied by the physical object 551 or at a position corresponding to the physical object 551, without outputting the virtual object 552 that substitutes the physical object 551. That is, the electronic device 501 may transmit, to the user 590, visual information representing the physical object 551 (e.g., light reflected from the physical object 551 or an image obtained by capturing the physical object 551) as it is without a change, and set the manipulation area in the corresponding physical object 551. The manipulation area may be set to have the same shape and volume as the space occupied by the virtual object 552 or the physical object 551 but is not limited thereto. The electronic device 501 may set the manipulation area that is smaller than the space occupied by the virtual object 552 or the space occupied by the physical object 551.

According to an embodiment, the electronic device 501 may arrange the virtual object 552 (e.g., an avatar object) representing the user 590 in the virtual space 500. When the avatar object is provided in a first-person view, the electronic device 501 may provide a visualized graphic representation corresponding to a portion of the avatar object (e.g., a hand, a torso, or a leg) to the user 590 via the display described above (e.g., an OST display or a VST display). However, embodiments are not limited thereto, and when the avatar object is provided in a third-person view, the electronic device 501 may provide a visualized graphic representation corresponding to the entire shape (e.g., a back view) of the avatar object to the user 590 via the display described above. The electronic device 501 may provide the user 590 with an experience integrated with the avatar object.

In addition, the electronic device 501 may provide an avatar object of another user who enters the same virtual space 500. The electronic device 501 may receive feedback information that is the same as or similar to feedback information (e.g., information based on at least one of visual sensation, auditory sensation, or tactile sensation) provided to another electronic device 501 entering the same virtual space 500. For example, when an object is arranged in any virtual space 500 and a plurality of users access the virtual space 500, respective electronic devices 501 of the plurality of users 590 may receive feedback information (e.g., a graphic representation, a sound signal, or haptic feedback) of the same object arranged in the virtual space 500 and provide the feedback information to each user 590.

The electronic device 501 may detect an input to an avatar object of another electronic device 501 and may receive feedback information from the avatar object of the other electronic device 501. An exchange of inputs and feedback for each virtual space 500 may be performed by a server (e.g., the server 108 of FIG. 1). For example, the server (e.g., a server providing a metaverse space) may transfer, to the users 590, inputs and feedback between the avatar object of the user 590 and an avatar object of another user 590. However, embodiments are not limited thereto, and the electronic device 501 may establish direct communication with the other electronic device 501 to provide an input based on an avatar object or receive feedback, not via the server.

For example, based on detecting a user input that selects a manipulation area, the electronic device 501 may determine that the physical object 551 corresponding to the selected manipulation area is selected by the user 590. An input of the user 590 may include at least one of a gesture input made by using a body part (e.g., a hand or eye), an input made by using a separate VR accessory device, or a voice input of the user.

The gesture input may be an input corresponding to a gesture identified by tracking a body part 510 of the user 590 and may include, for example, an input indicating or selecting an object. The gesture input may include at least one of a gesture by which a body part (e.g., a hand) moves toward an object for a predetermined period of time or more, a gesture by which a body part (e.g., a finger, an eye, or a head) points at an object, or a gesture by which a body part and an object contact each other spatially. A gesture of pointing at an object with an eye may be identified based on ET. A gesture of pointing at an object with a head may be identified based on head tracking.

Tracking the body part 510 of the user 590 may be mainly performed based on a camera of the electronic device 501 but is not limited thereto. The electronic device 501 may track the body part 510 based on a cooperation of sensing data of a vision sensor (e.g., image data of a camera and depth data of a depth sensor) and information collected by accessory devices to be described below (e.g., controller tracking or finger tracking in a controller). Finger tracking may be performed by sensing a distance or contact between an individual finger and the controller based on a sensor (e.g., an infrared sensor) embedded in the controller.

VR accessory devices may include, for example, a ride-on device, a wearable device, a controller device 520, or other sensor-based devices. The ride-on device, which is a device operated by the user 590 riding thereon, may include, for example, at least one of a treadmill-type device or a chair-type device. The wearable device, which is a manipulation device worn on at least a part of the body of the user 590, may include, for example, at least one of a full body suit-type or a half body suit-type controller, a vest-type controller, a shoe-type controller, a bag-type controller, a glove-type controller (e.g., a haptic glove), or a face mask-type controller. The controller device 520 may include, for example, an input device (e.g., a stick-type controller or a firearm) manipulated by a hand, foot, toe, or other body parts 510.

The electronic device 501 may establish direct communication with an accessory device and track at least one of a position or motion of the accessory device, but embodiments are not limited thereto. The electronic device 501 may communicate with the accessory device via a base station for VR.

For example, the electronic device 501 may determine that the virtual object 552 is selected, based on detecting an act of gazing at the virtual object 552 for a predetermined period of time or more through eye gaze tracking technology described above. In another example, the electronic device 501 may recognize a gesture of pointing at the virtual object 552 through hand tracking technology. The electronic device 501 may determine that the virtual object 552 is selected, based on that a direction in which a tracked hand points indicates the virtual object 552 for a predetermined period of time or more or that a hand of the user 590 contacts or enters an area occupied by the virtual object 552 in the virtual space 500.

The voice input of the user, which is an input corresponding to a user's voice obtained by the electronic device 501, may be sensed by, for example, an input module (e.g., a microphone) of the electronic device 501 or may include voice data received from an external electronic device of the electronic device 501. By analyzing the voice input of the user, the electronic device 501 may determine that the physical object 551 or the virtual object 552 is selected. For example, based on detecting a keyword indicating at least one of the physical object 551 or the virtual object 552 from the voice input of the user, the electronic device 501 may determine that at least one of the physical object 551 or the virtual object 552 corresponding to the detected keyword is selected.

The electronic device 501 may provide feedback to be described below as a response to the input of the user 590 described above.

The feedback may include visual feedback, auditory feedback, tactile feedback, olfactory feedback, or gustatory feedback. The feedback may be rendered by the server 108, the electronic device 101, or the external electronic device 102 as described above with reference to FIG. 1.

The visual feedback may include an operation of outputting an image through the display (e.g., a transparent display or an opaque display) of the electronic device 501.

The auditory feedback may include an operation of outputting a sound through a speaker of the electronic device 501.

The tactile feedback may include force feedback that simulates a weight, a shape, a texture, a dimension, and dynamics. For example, the haptic glove may include a haptic element (e.g., an electric muscle) that simulates a sense of touch by tensing and relaxing the body of the user 590. The haptic element in the haptic glove may act as a tendon. The haptic glove may provide haptic feedback to the entire hand of the user 590. The electronic device 501 may provide feedback that represents a shape, a size, and stiffness of an object through the haptic glove. For example, the haptic glove may generate force that simulates a shape, a size, and stiffness of an object. The exoskeleton of the haptic glove (or a suit-type device) may include a sensor and a finger motion measurement device, may transfer cable-pulling force (e.g., an electromagnetic, direct current (DC) motor-based, or pneumatic force) to fingers of the user 590, and may thereby transmit tactile information to the body. Hardware that provides such tactile feedback may include a sensor, an actuator, a power source, and a wireless transmission circuit. The haptic glove may operate by inflating and deflating an inflatable air bladder on a surface of the glove.

Based on an object in the virtual space 500 being selected, the electronic device 501 may provide feedback to the user 590. For example, the electronic device 501 may output a graphic representation (e.g., a representation of highlighting the selected object) indicating the selected object through the display. For example, the electronic device 501 may output a sound (e.g., a voice) notifying the selected object through a speaker. In another example, the electronic device 501 may transmit an electrical signal to a haptic supporting accessory device (e.g., the haptic glove) and may thereby provide a haptic motion that simulates a tactile sensation of a corresponding object to the user 590.

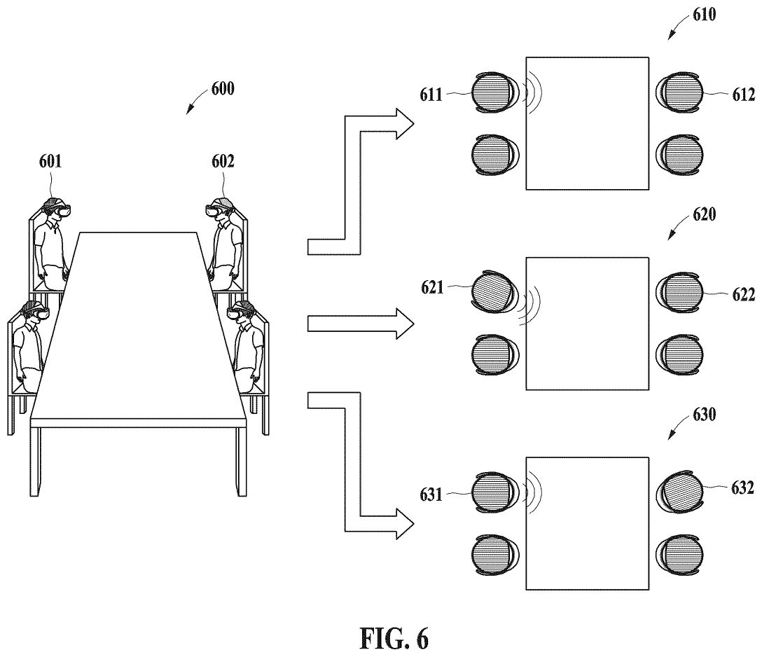

FIG. 6 is a diagram illustrating an example of transmitting voice data between a plurality of users in a virtual space, according to an embodiment of the disclosure.

Referring to FIG. 6, an electronic device (e.g., the electronic device 101 of FIG. 1, the electronic device 201 of FIG. 2, the electronic device 301 of FIG. 3, the electronic device 401 of FIGS. 4A and 4B, or the electronic device 501 of FIG. 5) may be worn by a user. The electronic device may be in a space 600. In various embodiments of the disclosure, the space 600 may include a physical space and/or a virtual space (e.g., the virtual space 500 of FIG. 5). The presence of the electronic device in the space 600 may indicate that, when the space 600 is a physical space, the position of the electronic device is included in an area defined as the space 600. When the space 600 is a virtual space, the presence of the electronic device in the space 600 may be interpreted as corresponding to a user 601 connecting (or entering) the virtual space, and the electronic device disconnecting from (or leaving) the space 600 may be interpreted as corresponding to the user 601 leaving the virtual space. The space 600 may be a virtual space constructed by at least one of a server (e.g., the server 108 of FIG. 1), the electronic device, and another electronic device (e.g., the electronic device 102 of FIG. 1 or the electronic device 104 of FIG. 1).

The electronic device may receive acoustic data from another electronic device in the same space 600. For example, the other electronic device may be worn by another user 602. The other electronic device may obtain acoustic data including voice data of the other user 602. The other electronic device may transmit the obtained acoustic data to the electronic device. The electronic device may receive the acoustic data. The electronic device may reproduce the received acoustic data (or a voice output obtained from the acoustic data). As a result, the user 601 wearing the electronic device and the other user 602 wearing the other electronic device may communicate with each other through the virtual space even when being located in different physical spaces. However, embodiments are not limited to the case in which the user 601 wearing the electronic device and the other user 602 wearing the other electronic device are located in different physical spaces, and the electronic device and the other electronic device may connect to the same virtual space while the user 601 and the other user 602 are located in the same physical space.

The electronic device in the space 600 may have a position and/or heading direction of the electronic device in the space. The position and heading direction of the electronic device may be individually set at the time of entering the space 600 in the initial position and initial heading direction. The position and heading direction of the electronic device may be changed based on an input of the user 601, which is received after the electronic device enters the space 600. With respect to the other electronic device entering the space 600, the electronic device may display a virtual object corresponding to the other electronic device based on a position and/or heading direction of the other electronic device. The virtual object corresponding to the other electronic device may include an avatar object corresponding to the other user 602.

When the user 601 and the other user 602 communicate with each other in the same physical space, even when the other user 602 makes the same utterance, the user 601 may recognize the utterance differently based on a direction (hereinafter, referred to as a “speaking direction”) in which the other user 602 looks while speaking and/or a direction (hereinafter, referred to as a “listening direction”) in which the user 601 looks while listening to the utterance of the other user 602. For example, the user 601 may listen to the utterance of the other user 602 differently when the user 601 and the other user 602 are facing each other head-on, when the user 601 looks at the other user 602 and the other user 602 turns his head to a predetermined angle, when the other user 602 looks at the user 601 and the user 601 turns his head to a predetermined angle, when the user 601 and the other user 602 turn their heads to a predetermined angle. For example, when the user 601 listens to the utterance of the other user 602, the user 601 may differently recognize at least one of the attenuation rate of a high-pitched component during utterance, the volume sensed through the left ear, or the volume sensed through the right ear, depending on the positions and/or rotation angles of the heads of the user 601 and the other user 602.

However, when the electronic device reproduces a voice input of the other user 602 without considering the positions and heading directions of the user 601 (or the electronic device) and/or the other user 602 (or the other electronic device) in the space 600, the user experience may be degraded due to the mismatch between the reproduced voice input and an acoustic characteristic (e.g., a high-pitched component attenuation rate, a volume for the left ear, or a volume for the right ear) according to the positions and/or heading directions of the user 601 and the other user 602 in the virtual space 600, which are recognized by the electronic device.

According to an embodiment, the electronic device may process the voice input of the other electronic device based on the position and/or heading direction of the other electronic device in the space 600. For example, the electronic device may generate a voice output that emulates a case in which the user 601 and the other user 602 communicate with each other in the position and/or heading direction in the space 600 in the same physical space, based on the positions and/or heading directions of the electronic device (or the user 601) and the other electronic device (or the other user 602) in the space 600.

For example, as shown in FIG. 6, a first user and a second user may be in the space 600. The first user may wear a first electronic device and the second user may wear a second electronic device.

In a first situation 610, a first electronic device of a first user 611 and a second electronic device of a second user 612 may face each other head-on in the space 600. The second electronic device may reproduce a voice output in which a high-pitched component attenuation rate that is less than or equal to a threshold attenuation rate is applied to the voice of the first user 611. Additionally, the second electronic device may reproduce the voice output at the same volume from a first speaker corresponding to the right ear of the second user 612 and a second speaker corresponding to the left ear of the second user 612.

In a second situation 620, in the space 600, a first electronic device of a first user 621 may have a heading direction that is different from the direction toward a second electronic device of a second user 622, and the second electronic device of the second user 622 may look at the first electronic device of the first user 621. The second electronic device may reproduce a voice output in which a high-pitched component attenuation rate exceeding a threshold attenuation rate is applied to the voice of the first user 621. Additionally, the second electronic device may reproduce the voice output at a first volume from a first speaker corresponding to the right ear of the second user 622 and reproduce the voice output at a second volume that is greater than the first volume from a second speaker corresponding to the left ear of the second user 622.

In a third situation 630, in the space 600, a first electronic device of a first user 631 may look at a second electronic device of a second user 632, and the second electronic device of the second user 632 may have a heading direction that is different from the direction toward the first electronic device of the first user 631. The second electronic device may reproduce a voice output in which a high-pitched component attenuation rate exceeding a threshold attenuation rate is applied to the voice of the first user 631. Additionally, the second electronic device may reproduce the voice output at a first volume from a first speaker corresponding to the right ear of the second user 632 and reproduce the voice output at a second volume that is less than the first volume from a second speaker corresponding to the left ear of the second user 632.

The electronic device according to an embodiment may adjust acoustic data based on the acoustic characteristics of the physical space and/or the space 600 around the other electronic device. For example, the electronic device may reproduce a voice output in which the acoustic characteristic of the physical space around the other electronic device is limited and the acoustic characteristic of the space 600 is added. The electronic device may reproduce a voice output that emulates the voice uttered by the other user while the other user is in the space 600 by limiting and/or adding the acoustic characteristic. For example, when the other electronic device is located in a cave and the space 600 is a virtual space that emulates an outdoor terrace, a voice output that emulates the voice uttered by the other user wearing the other electronic device on the outdoor terrace to the user wearing the electronic device may be reproduced as the acoustic characteristic according to the cave is limited and the acoustic characteristic according to the outdoor terrace is added.

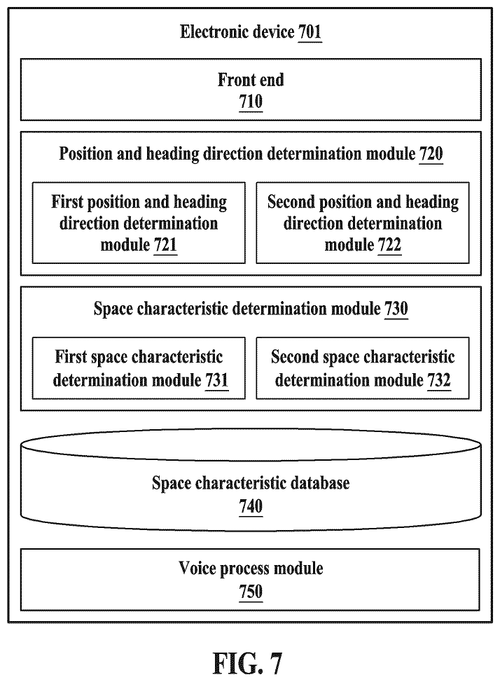

FIG. 7 is a diagram illustrating an example of an electronic device, according to an embodiment of the disclosure.

Referring to FIG. 7, an electronic device 701 (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5), according to an embodiment, may process a voice input received from another electronic device based on at least one of the positions and/or heading directions of the electronic device 701 and the other electronic device or a space characteristic.

The electronic device 701 according to an embodiment may include at least one of a front end 710, a position and heading direction determination module 720, a space characteristic determination module 730, a space characteristic database 740, or a voice process module 750.

The front end 710 may receive a voice input from a user wearing the electronic device 701. Alternatively, the front end 710 may receive a voice input from another electronic device, such as from another electronic device worn by another user.

The position and heading direction determination module 720 may determine the positions and heading directions of the electronic device 701 and the other electronic device in a space (e.g., the space 600 of FIG. 6). According to an embodiment, the position and heading direction determination module 720 may include at least one of a first position and heading direction determination module 721 or a second position and heading direction determination module 722.

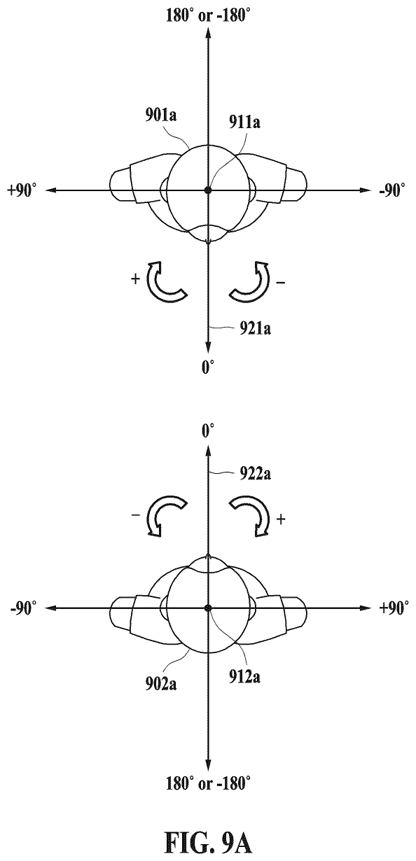

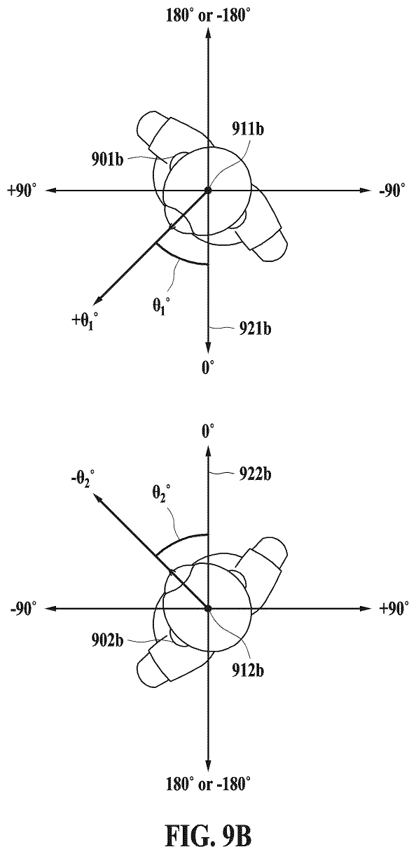

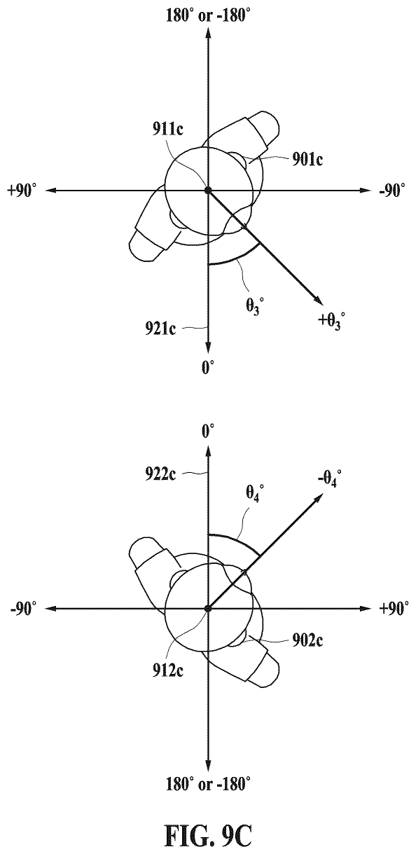

The first position and heading direction determination module 721 of an embodiment may determine the position and heading direction of the other electronic device in the space. The first position and heading direction determination module 721 may determine a speaking angle (e.g., 0°of FIG. 9A, +θ₁° of FIG. 9B, and −θ₃° of FIG. 9C) between a first reference direction (e.g., first reference directions 921a, 921b, and 921c of FIGS. 9A, 9B, and 9C) from the other electronic device to the electronic device 701 and the heading direction of the other electronic device. The speaking angle may be determined to be a value that is greater than or equal to −180° and less than or equal to +180°.

For example, the first position and heading direction determination module 721 may determine the position and heading direction of the other electronic device in the space based on a virtual object corresponding to the other electronic device displayed through a display. For example, the first position and heading direction determination module 721 may receive information about the position and heading direction of the other electronic device from the other electronic device and/or a server and determine the position and heading direction of the other electronic device based on the received information.

The second position and heading direction determination module 722 of an embodiment may determine the position and heading direction of the electronic device 701 in the space. The second position and heading direction determination module 722 may determine a listening angle (e.g., 0° of FIG. 9A, −θ₂° of FIG. 9B, and +θ₄° of FIG. 9C) between a second reference direction (e.g., second reference directions 922a, 922b, and 922c of FIGS. 9A, 9B, and 9C) that is opposite to the first reference direction and the heading direction of the electronic device 701. The second reference direction may be a direction from the electronic device 701 to the other electronic device. The listening angle may be determined to be a value that is greater than or equal to −180° and less than or equal to +180°.

The speaking angle and the listening angle are described in more detail below with reference to FIGS. 9A, 9B, and 9C.

The space characteristic determination module 730 may determine an acoustic characteristic according to a physical space around the electronic device 701. According to an embodiment, the space characteristic determination module 730 may include at least one of a first space characteristic determination module 731 or a second space characteristic determination module 732.

The acoustic characteristic according to a space (e.g., a physical space or a virtual space) may include at least one of a reverberation time or a tonal characteristic. The reverberation time may refer to a time required for the sound pressure of a test sound reproduced at the time of reproduction of the test sound to be reduced by 60 decibels (dB). However, this is an embodiment, and the reverberation time may be measured based on various criteria, such as the time required for the sound pressure to be reduced to 20 dB or 30 dB. The tonal characteristic may refer to a balance of each frequency band from low to high.

The first space characteristic determination module 731 of an embodiment may determine the acoustic characteristic according to the physical space around the electronic device 701 based on visual information. For example, the first space characteristic determination module 731 may obtain an image of the physical space around the electronic device 701. For example, the first space characteristic determination module 731 may determine the acoustic characteristic according to the physical space around the electronic device 701 based on the size of the physical space around the electronic device 701, a physical object (e.g., a desk or a chair) placed in the physical space, and/or a texture of a background that separates the physical space, which are determined from the obtained image.

The second space characteristic determination module 732 of an embodiment may determine the acoustic characteristic according to the physical space around the electronic device 701 based on acoustic information. For example, the second space characteristic determination module 732 may reproduce first sound data in the physical space around the electronic device 701. The first sound data may correspond to a predetermined reference sound. For example, the first sound data may be sound data with limited acoustic characteristics according to the physical space. The second space characteristic determination module 732 may obtain second sound data based on the reproduced first sound data. The second sound data may be a result of the addition of the acoustic characteristic according to the physical space around the electronic device 701 to the first sound data. The second space characteristic determination module 732 may determine the acoustic characteristic according to the physical space around the electronic device 701 by comparing the first sound data with the second sound data.

The space characteristic database 740 may store the acoustic characteristic according to the physical space and/or the virtual space. The space characteristic database 740 may store the acoustic characteristic according to the physical space determined by the space characteristic determination module 730. The space characteristic database 740 may store the acoustic characteristic according to the physical space received from an external device (e.g., another device or a server). The space characteristic database 740 may store the acoustic characteristic according to the virtual space obtained from a device (e.g., the electronic device 701, another electronic device, or a server) that constructs the virtual space.

In various embodiments of the disclosure, the space characteristic database 740 is mainly described as being included in the electronic device 701 but is not limited thereto. For example, the electronic device 701 may be implemented as a separate device from the space characteristic database 740 and may access the space characteristic database 740.

The voice process module 750 may process the acoustic data obtained from the electronic device 701 and/or the other electronic device.

For example, the voice process module 750 may generate a voice output from the acoustic data when obtaining the acoustic data from the other electronic device. For example, the voice process module 750 may attenuate a high-pitched component of the acoustic data based on the heading direction (or a speaking angle) of the other electronic device and/or the heading direction (or a listening angle) of the electronic device 701. For example, the voice process module 750 may add the acoustic characteristic according to the virtual space to the acoustic data.

For example, when first acoustic data is obtained from the electronic device 701 (or a user wearing the electronic device 701), the voice process module 750 may generate second acoustic data from the first acoustic data. The voice process module 750 may adjust the second acoustic data based on the acoustic characteristic of the physical space around the electronic device 701. For example, the voice process module 750 may limit (e.g., reduce or eliminate) the acoustic characteristic of the physical space around the electronic device 701 from a voice input. The front end 710 of the electronic device 701 may then transmit voice data to the other electronic device.

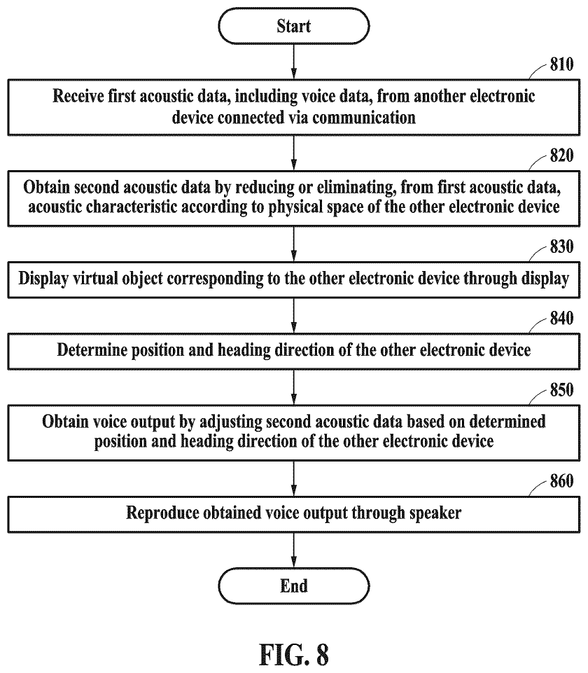

FIG. 8 is a diagram illustrating an example of a method in which an electronic device reproduces a voice output generated from acoustic data of another electronic device, according to an embodiment of the disclosure.

Referring to FIG. 8, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 701 of FIG. 7) may reproduce a voice output based on a voice input of another electronic device in the same space.

In operation 810, the electronic device may receive first acoustic data, including voice data, from another electronic device connected via communication. The electronic device and the other electronic device may be in the same space. The space where the electronic device and other electronic devices are located may include at least one of a physical space or a virtual space.

When the electronic device and the other electronic device are in the same virtual space, the electronic device and the other electronic device may access the virtual space.

The virtual space may be constructed as a stereoscopic space (e.g., a 3D space) and/or a planar space (e.g., a 2D space). Data corresponding to the virtual space may include at least one of information defining the space (e.g., a size or a boundary), information about each point in the space (e.g., a position, information about an object corresponding to a corresponding point, or a color), or information about an object included in the space.

According to an embodiment, the virtual space may be constructed in accordance with the physical space around the electronic device (or the other electronic device).

For example, the virtual space may be constructed based on a physical space (hereinafter, also referred to as a ‘first physical space’) around the other electronic device. By accessing the virtual space, the electronic device may provide a user experience that is similar to entering the first physical space to the user wearing the electronic device.

In another example, the virtual space may be constructed based on a physical space (hereinafter, also referred to as a ‘second physical space’) around the electronic device. By accessing the virtual space, the other electronic device may provide a user experience that is similar to entering the second physical space to another user wearing the other electronic device.

According to an embodiment, the virtual space may be constructed independently from the physical space around the electronic device (or the other electronic device). For example, the virtual space may be constructed based on the set information (e.g., a size of a virtual space or a placed object). By accessing the virtual space, the electronic device and the other electronic device may provide a user experience that is similar to entering the same space to the user wearing the electronic device and the other user wearing the other electronic device.

In various embodiments of the disclosure, it is mainly described that the electronic device and the other electronic device enter a single virtual space, but embodiments are not limited thereto. According to an embodiment, the electronic device and the other electronic device may access a virtual space constructed in correspondence with each of the electronic device and the other electronic device. For example, the electronic device and the other electronic device may access a first virtual space and a second virtual space. The first virtual space may refer to a virtual space constructed based on the physical space (e.g., the first physical space) around the other electronic device, and the second virtual space may refer to a virtual space constructed based on the physical space (e.g., the second physical space) around the electronic device. The electronic device may display an object corresponding to the other electronic device based on the access of the other electronic device to the first virtual space. The other electronic device may display an object corresponding to the electronic device based on the access of the electronic device to the second virtual space. By accessing the first virtual space and the second virtual space, the electronic device and the other electronic device may provide the user wearing the electronic device with a user experience that is similar to that of the other user wearing the other electronic device entering the first physical space, and at the same time provide the other user wearing the other electronic device with a user experience that is similar to that of the user wearing the electronic device entering the second physical space.

According to an embodiment, the other electronic device may obtain first acoustic data including voice data. The voice data may refer to data corresponding to the voice of the other user. The other electronic device may transmit the first acoustic data to the electronic device. The electronic device may receive the first acoustic data from the other electronic device.

In operation 820, the electronic device may obtain second acoustic data by reducing or eliminating, from the first acoustic data, an acoustic characteristic according to the physical space of the other electronic device. The second acoustic data may be obtained by adjusting the first acoustic data of the other electronic device based on the acoustic characteristic according to the physical space around the other electronic device.

The electronic device may obtain the second acoustic data by adjusting the first acoustic data based on the acoustic characteristic according to the first physical space. The first acoustic data may be a voice obtained by combining the voice data of the other user with the acoustic characteristic according to the first physical space. The electronic device may generate the second acoustic data from the first acoustic data based on the space where the electronic device exists together with the other electronic device.

For example, the electronic device may obtain the second acoustic data by eliminating, from the first acoustic data, the acoustic characteristic according to the physical space around the other electronic device, based on the space (e.g., a virtual space) being constructed independently from the physical space around the other electronic device. The electronic device may generate the second acoustic data by limiting the acoustic characteristic according to the first physical space from the first acoustic data when the virtual space is constructed independently from the first physical space. When the second acoustic data does not include the acoustic characteristic according to the first physical space, a user listening to the second acoustic data (or a voice output based on the second acoustic data) through the electronic device may not recognize the acoustic characteristic according to the first physical space, thereby preventing a degraded user experience resulting from recognizing the presence of the other user in the first physical space that is different from the physical space (e.g., the second physical space) of the user.

For example, the electronic device may obtain the second acoustic data by preserving the acoustic characteristic of the first acoustic data based on the space (e.g., a virtual space) being constructed in correspondence with the physical space around the other electronic device. The electronic device may not limit the acoustic characteristic according to the first physical space from the first acoustic data when the virtual space is constructed in correspondence with the first physical space. Even when the second acoustic data (or a voice output based on the second acoustic data) reproduced by the electronic device includes the acoustic characteristic according to the first physical space, since the virtual space is also constructed in correspondence with the first physical space, the user of the electronic device may recognize the acoustic characteristic of the second acoustic data (or a voice output based on the second acoustic data) as the acoustic characteristic according to the virtual space.

However, when the space (e.g., a virtual space) is constructed in accordance with the physical space around the other electronic device, the second acoustic data is not limited to preserving the acoustic characteristic according to the first physical space. For example, the electronic device may generate the second acoustic data by at least partially limiting the acoustic characteristic according to the first physical space from the first acoustic data. The electronic device may generate a voice output by at least partially adding the acoustic characteristic according to the virtual space to the second acoustic data received from the other electronic device. When the virtual space is constructed in accordance with the physical space around the other electronic device, the acoustic characteristic of the physical space around the other electronic device may be the same as or similar to the acoustic characteristic of the virtual space.

In various embodiments of the disclosure, it is mainly described that the electronic device obtains the second acoustic data from the first acoustic data, but embodiments are not limited thereto. According to an embodiment, the other electronic device may generate the second acoustic data by adjusting the first acoustic data based on the acoustic characteristic according to the first physical space. The other electronic device may transmit the second acoustic data to the electronic device. The electronic device may receive the second acoustic data from the other electronic device.

In operation 830, the electronic device may display a virtual object corresponding to the other electronic device through a display. The electronic device may display the other electronic device in the space where the other electronic device exists together with the electronic device. The virtual object corresponding to the other electronic device may include an avatar object of the other user wearing the other electronic device.

In operation 840, the electronic device may determine the position and heading direction of the other electronic device. For example, the electronic device may determine the position and heading direction of the other electronic device in the space based on the displayed virtual object. According to an embodiment, a position and heading direction determination module (e.g., the position and heading direction determination module 720 of FIG. 7) of the electronic device may determine the position and heading direction of the other electronic device based on the displayed virtual object.

In operation 850, the electronic device may obtain a voice output by adjusting the second acoustic data based on the determined position and heading direction of the other electronic device. The voice output may be generated from the second acoustic data based on the position and heading direction of the other electronic device in the virtual space.

In operation 860, the electronic device may reproduce the obtained voice output through a speaker.

The electronic device according to an embodiment may generate the voice output by adding, to the second acoustic data, the acoustic characteristic according to the virtual space. The acoustic characteristic according to the virtual space may be obtained by analyzing image data obtained by capturing the virtual space, and/or the acoustic characteristic according to the virtual space stored in a space characteristic database (e.g., the space characteristic database 740 of FIG. 7) may be obtained.

For example, the electronic device may generate the voice output having the acoustic characteristic according to the physical space around the electronic device, based on the virtual space being constructed in correspondence with the physical space around the electronic device. The electronic device may obtain the acoustic characteristic according to the virtual space based on the acoustic characteristic according to the second physical space when the virtual space is constructed in correspondence with the second physical space. For example, the electronic device may determine that the acoustic characteristic according to the second physical space is the same as the acoustic characteristic according to the virtual space. The electronic device may determine the acoustic characteristic according to the second physical space by analyzing image data for the second physical space and/or may obtain the acoustic characteristic according to the second physical space stored in the space characteristic database (e.g., the space characteristic database 740 of FIG. 7). The electronic device may add, to the second acoustic data, the acoustic characteristic according to the second physical space. By reproducing the voice output generated by adding, to the second acoustic data, the acoustic characteristic according to the second physical space, the electronic device may provide a user experience that is similar to that of the other user existing with the user in the second physical space.

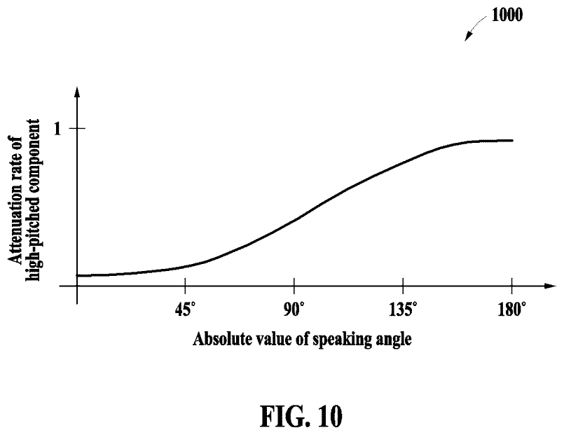

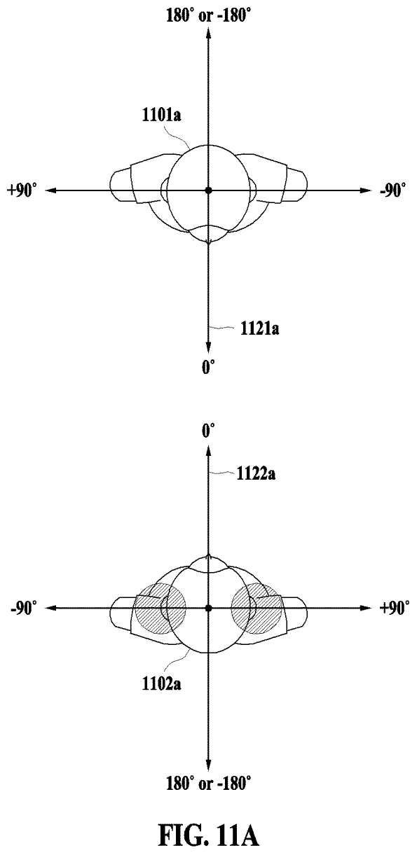

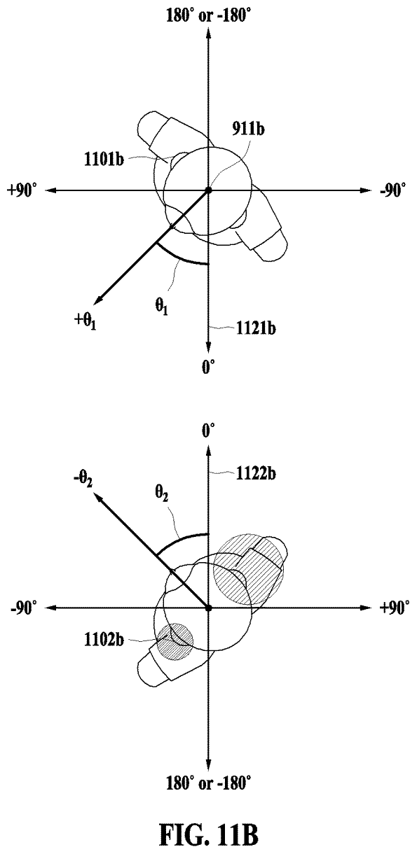

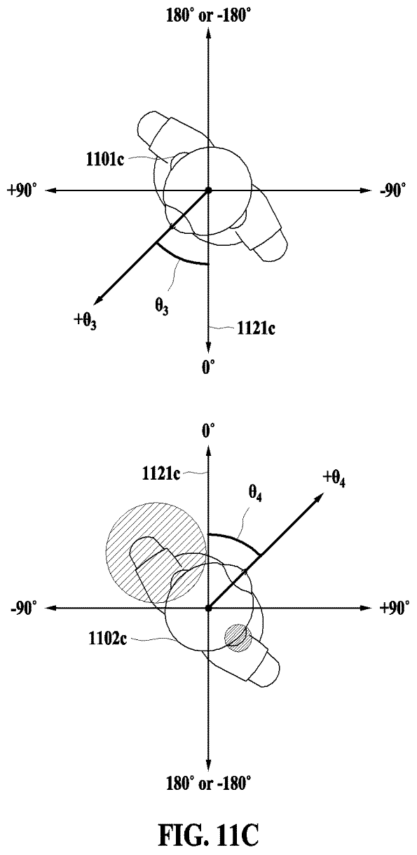

According to an embodiment, the voice output may be obtained from the second acoustic data based on the position and heading direction of the other electronic device. For example, the electronic device may determine a speaking angle and/or a listening angle based on the position and heading direction of the other electronic device in the virtual space. The electronic device may generate the voice output by adjusting the second acoustic data based on the speaking angle and/or the listening angle. For example, the electronic device may determine an attenuation rate of a high-pitched component of the second acoustic data based on the speaking angle and/or the listening angle. The electronic device may adjust the volume of a speaker corresponding to the right ear and the volume of a speaker corresponding to the left ear based on the speaking angle and/or the listening angle. The speaking angle and the listening angle are described in more detail below with reference to FIGS. 9A, 9B, and 9C, the attenuation rate of a high-pitched component is described in more detail below with reference to FIG. 10, and the volume adjustment of the speaker is described in more detail below with reference to FIGS. 11A, 11B, and 11C.

In various embodiments of the disclosure, it is mainly described that the physical space around the electronic device and the physical space around the other electronic device are different from each other, but embodiments are not limited thereto. According to an embodiment, the electronic device may exist in the same physical space with the other electronic device. For example, at least a portion of the physical space around the electronic device may be the same as at least a portion of the physical space around the other electronic device.

The electronic device according to an embodiment may adjust the volume for reproducing the voice output based on at least a portion of the physical space around the electronic device being the same as at least a portion of the physical space around the other electronic device.

When the electronic device and the other electronic device exist in the same physical space, the voice of the other user wearing the other electronic device may not only be obtained by the other electronic device but may also be recognized by the user wearing the electronic device directly (e.g., by propagating through the air in the physical space without going through the electronic device). Accordingly, even though the electronic device and the other electronic device exist in the same physical space, when the electronic device reproduces the voice output at a volume determined without considering the physical space, the user may recognize the voice of the other user that is directly recognized and the voice output reproduced through the electronic device together. As a result, an electronic device according to the comparative embodiment may reproduce the voice output at an excessively loud volume (e.g., a volume exceeding a threshold volume) to the user. In contrast, the electronic device according to an embodiment may reproduce the voice output at an appropriate volume (e.g., a threshold volume) by considering the voice of the other user, which is directly recognized, by adjusting (e.g., decreasing) the volume at which the voice output is reproduced, based on the presence of the electronic device and the other electronic device in the same physical space.

Although not explicitly shown in FIG. 8, the electronic device may obtain acoustic data (hereinafter, also referred to as “third acoustic data”) including voice data of the user wearing the electronic device and transmit fourth acoustic data obtained from the third acoustic data of the electronic device to the other electronic device.

According to an embodiment, the electronic device may obtain the third acoustic data including the voice data. The electronic device may determine the acoustic characteristic according to the physical space around the electronic device. For example, the electronic device may determine the acoustic characteristic according to the physical space around the electronic device from image data of the physical space around the electronic device, based on obtaining the third acoustic data. The electronic device may obtain the fourth acoustic data by reducing or eliminating, from the third acoustic data, the determined acoustic characteristic according to the physical space around the electronic device. The electronic device may transmit the fourth acoustic data to the other electronic device.

The electronic device may adjust the third acoustic data based on the physical space on which the virtual space is based, similarly to operation 820. For example, based on the virtual space being constructed independently from the physical space (e.g., the second physical space) around the electronic device, the electronic device may limit the acoustic characteristic according to the second physical space from the third acoustic data. The electronic device may transmit, to the other electronic device, the second acoustic data having limited acoustic characteristics according to the second physical space from the fourth acoustic data. In another example, based on the virtual space being constructed in correspondence with the second physical space, the electronic device may not limit the acoustic characteristic according to the second physical space from the first acoustic data. The electronic device may transmit, to the other electronic device, the second acoustic data that preserves the acoustic characteristic according to the second physical space.

FIGS. 9A, 9B, and 9C are diagrams illustrating examples of a speaking angle and a listening angle, according to various embodiments of the disclosure.

Referring to FIGS. 9A, 9B, and 9C, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 701 of FIG. 7) may process acoustic data based on a speaking angle and/or a listening angle. The electronic device may determine the speaking angle and/or the listening angle based on a position and heading direction of another electronic device in a virtual space.

In FIGS. 9A, 9B, and 9C, it may be described on the premise that speakers 901a, 901b, and 901c wear the other electronic device and listeners 902a, 902b, and 902c wear the electronic device. Additionally, the positions and heading directions of the speakers 901a, 901b, and 901c and the listeners 902a, 902b, and 902c illustrated in FIGS. 9A, 9B, and 9C may illustrate the positions and heading directions of the speakers 901a, 901b, and 901c (or the other electronic device) and the listeners 902a, 902b, and 902c (or the electronic device) in the virtual space. Hereinafter, for ease of description, the heading direction of the other electronic device is described as corresponding to the heading direction of a speaker, and the heading direction of the electronic device is described as corresponding to the heading direction of a listener.

The speaking angle may refer to an angle between first reference directions 921a, 921b, and 921c from the other electronic device to the electronic device and the heading direction of the other electronic device. The first reference directions 921a, 921b, and 921c may refer to directions from reference points 911a, 911b, and 911c of the other electronic device to reference points 912a, 912b, and 912c of the electronic device. For example, the first reference directions 921a, 921b, and 921c may be the heading directions of the speakers 901a, 901b, and 901c when the speakers 901a, 901b, and 901c (e.g., another user wearing the other electronic device) and the listeners 902a, 902b, and 902c (e.g., a user wearing the electronic device) are facing each other head-on. The reference points 911a, 911b, and 911c of the other electronic device may correspond, for example, to the center of the head of the other user wearing the other electronic device. The reference points 912a, 912b, and 912c of the electronic device may correspond, for example, to the center of the head of the user wearing the electronic device.

According to an embodiment, the speaking angle may be determined to be a value that is greater than or equal to −180° and less than or equal to +180°. The sign of the speaking angle may be determined based on the direction in which the heading directions of the speakers 901a, 901b, and 901c are rotated (e.g., a clockwise direction or a counterclockwise direction) with respect to the first reference directions 921a, 921b, and 921c. The direction in which the heading directions of the speakers 901a, 901b, and 901c are rotated with respect to the first reference directions 921a, 921b, and 921c may be determined based on a viewpoint viewed from above the speakers 901a, 901b, and 901c (e.g., from the heads of the speakers 901a, 901b, and 901c toward the legs). For example, in FIGS. 9A, 9B, and 9C, when the heading directions of the speakers 901a, 901b, and 901c are rotated in a clockwise direction with respect to the first reference directions 921a, 921b, and 921c, the speaking angle may have a positive sign. When the heading directions of the speakers 901a, 901b, and 901c are rotated in a counterclockwise direction with respect to the first reference directions 921a, 921b, and 921c, the speaking angle may have a negative sign.

The listening angle may refer to an angle between second reference directions 922a, 922b, and 922c that are opposite to the first reference directions 921a, 921b, and 921c and the heading direction of the electronic device. The second reference directions 922a, 922b, and 922c may refer to directions from the reference points 912a, 912b, and 912c of the electronic device to the reference points 911a, 911b, and 911c of the other electronic device. For example, the second reference directions 922a, 922b, and 922c may be the heading directions of the listeners 902a, 902b, and 902c when the speakers 901a, 901b, and 901c (e.g., the other user wearing the other electronic device) and the listeners 902a, 902b, and 902c (e.g., the user wearing the electronic device) are facing each other head-on.

According to an embodiment, the listening angle may be determined to be a value that is greater than or equal to −180° and less than or equal to +180°. The sign of the listening angle may be determined based on the direction in which the heading directions of the listeners 902a, 902b, and 902c are rotated (e.g., in a clockwise direction or in a counterclockwise direction) with respect to the second reference directions 922a, 922b, and 922c. The direction in which the heading directions of the listeners 902a, 902b, and 902c are rotated with respect to the second reference directions 922a, 922b, and 922c may be determined based on a viewpoint viewed from above the listeners 902a, 902b, and 902c (e.g., from the heads of the listeners 902a, 902b, and 902c toward the legs). For example, in FIGS. 9A, 9B, and 9C, when the heading directions of the listeners 902a, 902b, and 902c are rotated in a clockwise direction with respect to the second reference directions 922a, 922b, and 922c, the listening angle may have a positive sign. When the heading directions of the listeners 902a, 902b, and 902c are rotated in a counterclockwise direction with respect to the second reference directions 922a, 922b, and 922c, the listening angle may have a negative sign.

In FIG. 9A, the speaker 901a and the listener 902a may face each other head-on in the virtual space. The speaking angle may be determined to be 0°and the listening angle may be determined to be 0°.

In FIG. 9B, the heading direction of the speaker 901b in the virtual space may be rotated by a first angle θ₁° in a clockwise direction from the first reference direction 921b, and the heading direction of the listener 902b may be rotated by a second angle θ₂° in a counterclockwise direction from the second reference directions 922b. The speaking angle may be determined to be +θ₁° and the listening angle may be determined to be −θ₂°.

In FIG. 9C, the heading direction of the speaker 901c in the virtual space may be rotated by a third angle θ₃° in a counterclockwise direction from the first reference direction 921c, and the heading direction of the listener 902c may be rotated by a fourth angle θ₄° in a clockwise direction from the second reference direction 922c. The speaking angle may be determined to be −θ₃° and the listening angle may be determined to be +θ₄°.

The electronic device according to an embodiment may attenuate a high-pitched component of the acoustic data based on the determined speaking angle and listening angle and/or determine the volume of a first speaker corresponding to the right ear of a listener and the volume of a second speaker corresponding to the left ear of a listener. The attenuation of the high-pitched component is described in more detail below with reference to FIG. 10, and the determination of the volume of the speaker is described in more detail below with reference to FIGS. 11A, 11B, and 11C.

FIG. 10 is a diagram illustrating an example of an operation in which an electronic device attenuates a high-pitched component of acoustic data, according to an embodiment of the disclosure.

Referring to FIG. 10, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 701 of FIG. 7) may determine a high-pitched component attenuation rate of acoustic data based on a speaking angle.

The electronic device may attenuate the high-pitched component of the acoustic data (e.g., second acoustic data) based on the speaking angle between a first reference direction from another electronic device to the electronic device and a heading direction of the other electronic device. The high-pitched component of the acoustic data may refer to a component of a frequency band corresponding to the high-pitched component of the acoustic data. The frequency band corresponding to the high-pitched component may include a frequency that is greater than or equal to a threshold frequency. The threshold frequency may be, but is not limited thereto, 800 Hertz (Hz) and may be changed depending on the design.

According to an embodiment, the electronic device may determine an attenuation rate of the high-pitched component (hereinafter, also referred to as a ‘high-pitched component attenuation rate’) of the acoustic data based on the absolute value of the speaking angle. The high-pitched component attenuation rate may have a value that is greater than or equal to 0 and less than or equal to 1. The electronic device may attenuate the high-pitched component by applying the high-pitched component attenuation rate to the size (e.g., a volume) of the high-pitched component of the acoustic data. The electronic device may generate a voice output by combining the attenuated high-pitched component of the acoustic data with a remaining component (e.g., a low-pitched component) of the acoustic data.

For example, the electronic device may apply a greater high-pitched component attenuation rate as the absolute value of the speaking angle increases. The electronic device may apply, to the acoustic data, a second high-pitched component attenuation rate with respect to a second speaking angle, instead of a first high-pitched component attenuation rate. The second high-pitched component attenuation rate may have a greater value than the first high-pitched component attenuation rate. The first high-pitched component attenuation rate may be applied to the acoustic data with respect to a first speaking angle. The second speaking angle may have a greater absolute value than the first speaking angle.

The electronic device may apply a high-pitched component attenuation rate that increases gradually (e.g., with a first average slope) as the absolute value of the speaking angle increases in a section where the absolute value of the speaking angle is less than a first threshold absolute value. The electronic device may apply a high-pitched component attenuation rate that increases rapidly (e.g., with a second average slope) as the absolute value of the speaking angle increases in a section where the absolute value of the speaking angle is greater than or equal to the first threshold absolute value and less than a second threshold absolute value. The electronic device may apply a high-pitched component attenuation rate that increases gradually (e.g., with a third average slope) as the absolute value of the speaking angle increases in a section where the absolute value of the speaking angle is greater than or equal to the second threshold absolute value and less than a third threshold absolute value. The second average slope may be less than the first average slope and the third average slope.

A model 1000 illustrated in FIG. 10 may represent an example of the high-pitched component attenuation rate according to the absolute value of the speaking angle. As shown in FIG. 10, for example, the slope of the model 1000 may have a larger slope (e.g., an average slope) in a second section in which the absolute value of the speaking angle is greater than or equal to a second absolute value (e.g., 45°) and less than or equal to a third absolute value (e.g., 135°) than in a first section in which the absolute value of the speaking angle is greater than or equal to a first absolute value (e.g., 0°) and less than or equal to the second absolute value (e.g., 45°). The slope of the model 1000 may have a smaller slope (e.g., an average slope) in a third section in which the absolute value of the speaking angle is greater than or equal to the third absolute value (e.g., 135°) and less than a fourth absolute value (e.g., 180°) than in the second section in which the absolute value of the speaking angle is greater than or equal to the second absolute value (e.g., 45°) and less than the third absolute value (e.g., 135°).

FIGS. 11A, 11B, and 11C are diagrams illustrating examples of an operation of determining a volume of a speaker, according to various embodiments of the disclosure.

Referring to FIGS. 11A, 11B, and 11C, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 701 of FIG. 7) may determine the volume of a speaker for reproducing a voice output of another electronic device based on a speaking angle and/or a listening angle.

In FIGS. 11A, 11B, and 11C, it may be described on the premise that speakers 1101a, 1101b, and 1101c wear the other electronic device and listeners 1102a, 1102b, and 1102c wear the electronic device. Additionally, the positions and heading directions of the speakers 1101a, 1101b, and 1101c and the listeners 1102a, 1102b, and 1102c illustrated in FIGS. 11A, 11B, and 11C may illustrate the positions and heading directions of the speakers 1101a, 1101b, and 1101c (or the other electronic device) and the listeners 1102a, 1102b, and 1102c (or the electronic device) in a virtual space.

The electronic device according to an embodiment may include a first speaker (e.g., the first speaker 255a of FIG. 2) and a second speaker (e.g., the second speaker 255b of FIG. 2). The first speaker may correspond to the right ear of a user wearing the electronic device and the second speaker may correspond to the left ear of the user wearing the electronic device.

The electronic device may determine a first volume for the first speaker and a second volume for the second speaker based on the position and heading direction of the other electronic device in a space. For example, the electronic device may determine a reference volume based on the distance between the position of the other electronic device and the position of the electronic device in the virtual space. The electronic device may determine the reference volume to be a smaller value as the distance between the other electronic device and the electronic device increases. The electronic device may determine a speaking angle and a listening angle based on the position and heading direction of the other electronic device. The electronic device may adjust the first volume for the first speaker and the second volume for the second speaker based on at least one of the speaking angle or the listening angle.

The electronic device may adjust the first volume and the second volume based on at least one of the speaking angle or the listening angle.

According to an embodiment, the electronic device may determine the relationship in magnitude between the reference volume and the first volume or the second volume based on the sign of the speaking angle.

For example, the electronic device may adjust the first volume to be less than the reference volume based on the speaking angle having a positive sign. Additionally, the electronic device may adjust the second volume to be greater than the reference volume based on the speaking angle having a positive sign. That is, the electronic device may adjust the first volume to a value that is smaller than the reference volume based on the rotation of the speaking direction in a clockwise direction based on a first reference direction. The electronic device may adjust the second volume to a value that is greater than the reference volume based on the rotation of the speaking direction in a clockwise direction based on the first reference direction.

In another example, the electronic device may adjust the first volume to be greater than the reference volume based on the speaking angle having a negative sign. Additionally, the electronic device may adjust the second volume to be less than the reference volume based on the speaking angle having a negative sign. That is, the electronic device may adjust the first volume to a value that is greater than the reference volume based on the rotation of the speaking direction in a counterclockwise direction based on the first reference direction. The electronic device may adjust the second volume to a value that is smaller than the reference volume based on the rotation of the speaking direction in a counterclockwise direction based on the first reference direction.

When the speaking angle has a positive sign, that is, when the speaking direction rotates in a clockwise direction based on the first reference direction, as the head of a speaker rotates to the left from the viewpoint of a listener, the first volume of the first speaker corresponding to the left ear may increase and the second volume of the second speaker corresponding to the right ear may decrease. Conversely, when the speaking angle has a negative sign, that is, when the speaking direction rotates in a clockwise direction based on the first reference direction, as the head of the speaker rotates to the right from the viewpoint of the listener, the first volume of the first speaker corresponding to the left ear may decrease and the second volume of the second speaker corresponding to the right ear may increase.

According to an embodiment, the electronic device may determine a difference between the first volume and the reference volume and a difference between the second volume and the reference volume, based on the size of the absolute value of the speaking angle. For example, the electronic device may have a larger difference between the first volume and the reference volume as the absolute value of the speaking angle increases. The electronic device may have a larger difference between the second volume and the reference volume as the absolute value of the speaking angle increases.

According to an embodiment, the electronic device may determine the relationship in magnitude between the reference volume and the first volume and the second volume based on the sign of the listening angle.

For example, the electronic device may adjust the first volume to be less than the reference volume based on the listening angle having a positive sign. Additionally, the electronic device may adjust the second volume to be greater than the reference volume based on the listening angle having a positive sign. That is, the electronic device may adjust the first volume to a value that is smaller than the reference volume based on the rotation of the listening direction in a clockwise direction based on a second reference direction. The electronic device may adjust the second volume to a value that is greater than the reference volume based on the rotation of the listening direction in a clockwise direction based on the second reference direction.

In another example, the electronic device may adjust the first volume to be greater than the reference volume based on the listening angle having a negative sign. Additionally, the electronic device may adjust the second volume to be less than the reference volume based on the listening angle having a negative sign. That is, the electronic device may adjust the first volume to a value that is greater than the reference volume based on the rotation of the listening direction in a counterclockwise direction based on the second reference direction. The electronic device may adjust the second volume to a value that is smaller than the reference volume based on the rotation of the listening direction in a counterclockwise direction based on the second reference direction.

When the listening angle has a positive sign, that is, when the listening direction rotates in a clockwise direction based on the second reference direction, as the left ear of a listener approaches a speaker and the right ear of the listener moves away from the speaker in the virtual space, the first volume of the first speaker corresponding to the left ear may increase and the second volume of the second speaker corresponding to the right ear may decrease. Conversely, when the listening angle has a negative sign, that is, when the listening direction rotates in a clockwise direction based on the second reference direction, as the left ear of the listener moves away from the speaker and the right ear of the listener approaches the speaker in the virtual space, the first volume of the first speaker corresponding to the left ear may decrease and the second volume of the second speaker corresponding to the right ear may increase.

According to an embodiment, the electronic device may determine a difference between the first volume and the reference volume and a difference between the second volume and the reference volume, based on the size of the absolute value of the listening angle. For example, the electronic device may adjust the difference between the first volume and the reference volume to be greater as the absolute value of the listening angle increases. The electronic device may adjust the difference between the second volume and the reference volume to be greater as the absolute value of the listening angle increases.

The electronic device may reproduce the voice output through the first speaker at the determined first volume. The electronic device may reproduce the voice output through the second speaker at the determined second volume.

The electronic device according to an embodiment may determine the difference between the first volume and the second volume based on a first rotation direction of the heading direction of the other electronic device with respect to the first reference direction and a second rotation direction of the heading direction of the electronic device with respect to the second reference direction.

The electronic device may determine the first rotation direction of the heading direction of the other electronic device with respect to the first reference direction to be one of a clockwise direction or a counterclockwise direction. The electronic device may determine the second rotation direction of the heading direction of the electronic device with respect to the second reference direction to be one of a clockwise direction or a counterclockwise direction.

The electronic device may adjust the first volume and the second volume to have a smaller volume difference when the first rotation direction and the second rotation direction are different from each other, compared to when the first rotation direction and the second rotation direction are the same. For example, the electronic device may adjust the first volume for the first speaker and the second volume for the second speaker to have a first volume difference based on the first rotation direction being the same as the second rotation direction. The electronic device may adjust the first volume and the second volume to have a second volume difference that is less than the first volume difference, based on the first rotation direction being different from the second rotation direction.

In FIG. 11A, the speaker 1101a and the listener 1102a may face each other head-on in the virtual space. That is, the heading direction of the speaker 1101a may be a first reference direction 1121a, and the heading direction of the listener 1102a may be a second reference direction 1122a. The speaking angle may be determined to be 0°, and the listening angle may be determined to be 0°. Based on the fact that both the speaking angle and the listening angle are 0°, the electronic device may determine the first volume and the second volume to be the same value as the reference volume.

In FIG. 11B, the heading direction of the speaker 1101b in the virtual space may be rotated by a first angle θ₁° in a clockwise direction from a first reference direction 1121b, and the heading direction of the listener 1102b may be rotated by a second angle θ₂° in a counterclockwise direction from a second reference direction 1122b. The speaking angle may be determined to be +θ₁° and the listening angle may be determined to be −θ₂°.

The electronic device may determine the first volume that is decreased by a first volume adjustment determined based on the speaking angle and increased by a second volume adjustment determined based on the listening angle, from the reference volume. For example, the electronic device may determine, to be the first volume, a value obtained by subtracting the first volume adjustment from the reference volume and adding the second volume adjustment to the reference volume. The electronic device may determine the second volume that is increased by a third volume adjustment determined based on the speaking angle and decreased by a fourth volume adjustment determined based on the listening angle, from the reference volume. For example, the electronic device may determine, to be the second volume, a value obtained by adding the third volume adjustment to the reference volume and subtracting the fourth volume adjustment from the reference volume.

In FIG. 11C, the heading direction of the speaker 1101c in the virtual space may be rotated by a third angle θ₃° in a clockwise direction from a first reference direction 1121c, and the heading direction of the listener 1102c may be rotated by a fourth angle θ₄° in a clockwise direction from a second reference direction 1122c. The speaking angle may be determined to be +θ₃° and the listening angle may be determined to be +θ₄°.

The electronic device may determine the first volume that is decreased by a fifth volume adjustment determined based on the speaking angle and decreased by a sixth volume adjustment determined based on the listening angle, from the reference volume. For example, the electronic device may subtract the fifth volume adjustment and the sixth volume adjustment from the reference volume. The electronic device may determine the second volume that is increased by a seventh volume adjustment determined based on the speaking angle and increased by an eighth volume adjustment determined based on the listening angle, from the reference volume. For example, the electronic device may add the seventh volume adjustment and the eighth volume adjustment to the reference volume.

In various embodiments of the disclosure, it is mainly described that the electronic device adjusts the first volume and the second volume, but embodiments are not limited thereto. For example, the first volume and the second volume may be adjusted by a server. According to an embodiment, the other electronic device may transmit a voice input and/or voice data to the server. The server may generate a voice output from the voice data based on the position and heading direction of the other electronic device. The server may adjust the first volume and the second volume for reproducing the voice output. The server may transmit the voice output, the first volume, and the second volume to the electronic device. The electronic device may receive the voice output, the first volume, and the second volume from the server. The electronic device may reproduce the voice output at the first volume from the first speaker and reproduce the voice output at the second volume from the second speaker.

The electronic device may determine that the difference between the first volume and the second volume is greater when the first rotation direction and the second rotation direction are the same, as shown in FIG. 11C, than when the first rotation direction and the second rotation direction are different from each other, as shown FIG. 11B.

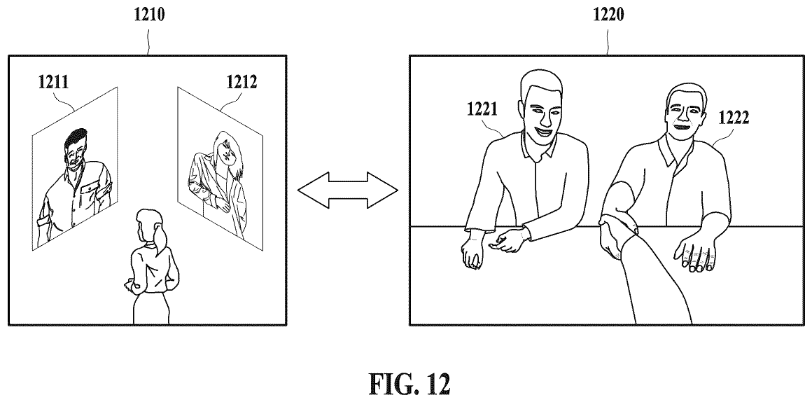

FIG. 12 illustrates an example of an interface of an electronic device, according to an embodiment of the disclosure.

Referring to FIG. 12, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 701 of FIG. 7), according to an embodiment, may display another electronic device (or another user) in the same space through at least one interface among a plurality of interfaces. The plurality of interfaces may include a window interface 1210 and an avatar interface 1220.

The window interface 1210 may refer to an interface in which an object corresponding to the other electronic device (or the other user) is displayed through a window (e.g., a first window 1211 or a second window 1212). The object corresponding to the other electronic device may include an image obtained by capturing the other user, an avatar object corresponding to the other user, and/or an image (e.g., a profile picture) set by the other user. The electronic device may adjust at least one of the window's position, size, brightness, filter, or whether to display based on a user input.

When the object corresponding to the other electronic device (or the other user) is displayed through the window interface 1210, the electronic device may determine the position and heading direction of the other electronic device based on the position and heading direction of the window. For example, the position of the other electronic device may be determined based on the position of the window displaying the object corresponding to the other electronic device (or the other user) in a space. The heading direction of the other electronic device may be determined based on the pose of the window displaying the object corresponding to the other electronic device (or the other user) in the space. According to an embodiment, the heading direction of the other electronic device may be determined to be the normal direction of a plane corresponding to the window. The electronic device may reproduce a voice output generated from voice data of the other electronic device using the position and heading direction of the other electronic device determined based on the window.

The avatar interface 1220 may refer to an interface displayed as an avatar object (e.g., a first avatar object 1221 or a second avatar object 1222) corresponding to the other electronic device (or the other user).

When the avatar object corresponding to the other electronic device is displayed through the avatar interface 1220, the electronic device may determine the position and heading direction of the other electronic device based on the position and heading direction of the avatar object. For example, the position of the other electronic device may be determined based on the position of the avatar object corresponding to the other electronic device in the space. The heading direction of the other electronic device may be determined based on the pose of the avatar object displaying the avatar object corresponding to the other electronic device in the space. According to an embodiment, the heading direction of the other electronic device may be determined to be the heading direction of the avatar object. The electronic device may reproduce the voice output generated from the voice data of the other electronic device using the position and heading direction of the other electronic device determined based on the avatar object corresponding to the other electronic device.

The electronic device may perform switching between the plurality of interfaces based on the user input. For example, the electronic device may perform switching between the window interface 1210 and the avatar interface 1220. When the user input corresponding to the interface switching is obtained while displaying the window interface 1210, the electronic device may stop displaying the window interface 1210 and display the avatar interface 1220. Alternatively, when the user input corresponding to the interface switching is obtained while displaying the avatar interface 1220, the electronic device may stop displaying the avatar interface 1220 and display the window interface 1210.

As described above, since the position and heading direction of the other electronic device in each of the window interface 1210 and the avatar interface 1220 are determined based on criteria corresponding to a corresponding interface, the position and heading direction of the other electronic device in the window interface 1210 may be different from the position and heading direction of the other electronic device in the avatar interface 1220. As a result, according to the interface switching, changes in the position and heading direction of the other electronic device may occur, and changes in the voice output generated based on the position and heading direction of the other electronic device may occur.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a complier or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a processor;
memory storing instructions;
a display; and
a speaker,
wherein the instructions, when executed by the processor, cause the electronic device to:
receive, from other electronic device connected via communication, first acoustic data comprising voice data,
obtain second acoustic data by reducing or eliminating, from the first acoustic data, an acoustic characteristic according to a physical space around the other electronic device,
display a virtual object corresponding to the other electronic device through the display,
identify a position and a heading direction of the other electronic device,
obtain a voice output by adjusting the second acoustic data based on the identified position and the identified heading direction of the other electronic device, and
reproduce the obtained voice output through the speaker.

2. The electronic device of claim 1, wherein the instructions, when executed by the processor, cause the electronic device to attenuate a high-pitched component of the second acoustic data based on a speaking angle between a first reference direction from the other electronic device to the electronic device and the heading direction of the other electronic device.

3. The electronic device of claim 1, wherein the instructions, when executed by the processor, cause the electronic device to obtain the second acoustic data by preserving an acoustic characteristic of the first acoustic data, based on a space, where the electronic device and the other electronic device are located, being constructed in correspondence with the physical space around the other electronic device.

4. The electronic device of claim 1, wherein the instructions, when executed by the processor, cause the electronic device to generate a voice output having an acoustic characteristic according to a physical space around the electronic device, based on a space, where the electronic device and the other electronic device are located, being constructed in correspondence with the physical space around the electronic device.

5. The electronic device of claim 1, wherein the instructions, when executed by the processor, cause the electronic device to obtain the second acoustic data by eliminating, from the first acoustic data, the acoustic characteristic according to the physical space around the other electronic device, based on a space, where the electronic device and the other electronic device are located, being constructed independently from the physical space around the other electronic device.

6. The electronic device of claim 1, wherein the instructions, when executed by the processor, cause the electronic device to:
obtain, from the electronic device, third acoustic data comprising voice data;
determine the acoustic characteristic according to the physical space around the electronic device;
obtain fourth acoustic data by reducing or eliminating, from the third acoustic data, the acoustic characteristic according to the physical space around the electronic device; and
transmit the obtained fourth acoustic data to the other electronic device.

7. The electronic device of claim 1, wherein the instructions, when executed by the processor, cause the electronic device to determine the acoustic characteristic according to the physical space around the electronic device from image data of the physical space around the electronic device, based on obtaining third acoustic data.

8. The electronic device of claim 1,
wherein the speaker comprises:
a first speaker, and
a second speaker, and
wherein the instructions, when executed by the processor, cause the electronic device to determine a first volume for the first speaker and a second volume for the second speaker, based on the position of the other electronic device and the heading direction of the other electronic device in a space where the electronic device and the other electronic device are located.

9. The electronic device of claim 1,
wherein the speaker comprises:
a first speaker, and
a second speaker, and
wherein the instructions, when executed by the processor, cause the electronic device to adjust a first volume for the first speaker and a second volume for the second speaker, based on at least one of a speaking angle between a first reference direction and the heading direction of the other electronic device, or a listening angle between a second reference direction that is opposite to the first reference direction and a heading direction of the electronic device.

10. The electronic device of claim 1,
wherein the speaker comprises:
a first speaker, and
a second speaker, and
wherein the instructions, when executed by the processor, cause the electronic device to:
determine a first rotation direction of the heading direction of the other electronic device with respect to a first reference direction from the other electronic device to the electronic device to be one of a clockwise direction or a counterclockwise direction,
determine a second rotation direction of the heading direction of the electronic device with respect to a second reference direction that is opposite to the first reference direction to be one of a clockwise direction or a counterclockwise direction,
adjust a first volume for the first speaker and a second volume for the second speaker to have a first volume difference, based on the first rotation direction being equal to the second rotation direction, and
adjust the first volume and the second volume to have a second volume difference that is less than the first volume difference, based on the first rotation direction being different from the second rotation direction.

11. The electronic device of claim 1, wherein the instructions, when executed by the processor, cause the electronic device to adjust a volume at which the voice output is reproduced, based on at least a portion of the physical space around the electronic device being equal to at least a portion of the physical space around the other electronic device.

12. A method performed by an electronic device, the method comprising:
receiving, from other electronic device connected via communication, first acoustic data comprising voice data;
obtaining second acoustic data by reducing or eliminating, from the first acoustic data, an acoustic characteristic according to a physical space around the other electronic device;
displaying a virtual object corresponding to the other electronic device through a display;
identifying a position and a heading direction of the other electronic device;
obtaining a voice output by adjusting the second acoustic data based on the identified position and the identified heading direction of the other electronic device; and
reproducing the obtained voice output through a speaker.

13. The method of claim 12, wherein the obtaining of the voice output comprises attenuating a high-pitched component of the second acoustic data based on a speaking angle between a first reference direction from the other electronic device to the electronic device and the heading direction of the other electronic device.

14. The method of claim 12, wherein the obtaining of the second acoustic data comprises obtaining the second acoustic data by preserving an acoustic characteristic of the first acoustic data, based on a space, where the electronic device and the other electronic device are located, being constructed in correspondence with the physical space around the other electronic device.

15. The method of claim 12, further comprising:
generating a voice output having an acoustic characteristic according to a physical space around the electronic device, based on a space, where the electronic device and the other electronic device are located, being constructed in correspondence with the physical space around the electronic device.

16. The method of claim 12, further comprising:
obtaining the second acoustic data by eliminating, from the first acoustic data, the acoustic characteristic according to the physical space around the other electronic device, based on a space, where the electronic device and the other electronic device are located, being constructed independently from the physical space around the other electronic device.

17. The method of claim 12, further comprising:
obtaining, from the electronic device, third acoustic data comprising voice data;
determining the acoustic characteristic according to the physical space around the electronic device;
obtaining fourth acoustic data by reducing or eliminating, from the third acoustic data, the acoustic characteristic according to the physical space around the electronic device; and
transmitting the obtained fourth acoustic data to the other electronic device.

18. The method of claim 12, further comprising:
determining the acoustic characteristic according to the physical space around the electronic device from image data of the physical space around the electronic device, based on obtaining third acoustic data.

19. One or more non-transitory computer-readable storage media storing one or more computer programs including computer-executable instructions that, when executed by one or more processors of an electronic device individually or collectively, cause the electronic device to perform operations, the operations comprising:
receiving, from other electronic device connected via communication, first acoustic data comprising voice data;
obtaining second acoustic data by reducing or eliminating, from the first acoustic data, an acoustic characteristic according to a physical space around the other electronic device;
displaying a virtual object corresponding to the other electronic device through a display;
identifying a position and a heading direction of the other electronic device;
obtaining a voice output by adjusting the second acoustic data based on the identified position and the identified heading direction of the other electronic device; and
reproducing the obtained voice output through a speaker.

20. The one or more non-transitory computer-readable storage media of claim 19, the operations further comprising:
attenuating a high-pitched component of the second acoustic data based on a speaking angle between a first reference direction from the other electronic device to the electronic device and the heading direction of the other electronic device.
